(19) United States
(12) Patent Application Publication
(10) Pub. No.: US 2020/0200120 A1
(43) Pub. Date: Jun. 25, 2020

(54) ENGINE ROTATIONAL SPEED VARIATION AMOUNT DETECTING DEVICE AND ENGINE CONTROL DEVICE

(71) Applicant: MAHLE ELECTRIC DRIVES JAPAN CORPORATION, SHIZUOKA-KEN (JP)

(72) Inventor: Kiyoshi UEMURA, SHIZUOKA-KEN (JP)

(21) Appl. No.: 16/622,350

(22) PCT Filed: Jun. 26, 2017
(86) PCT No.: PCT/JP2017/023424

§ 371 Date: Dec. 13, 2019

(51) Int. Cl. F02D 45/00; F02D 41/00

(52) U.S. Cl. CPC F02D 45/00; F02D 43/00; F02D 41/009

(57) ABSTRACT

Provided is a device that detects a rotational speed variation amount of a multi-cylinder four-cycle engine, a rotation signal corresponding to each of the cylinders are generated once per one rotation of a crankshaft, an amount of time elapsed from a previous generation to a current generation of the rotation signal corresponding to each of the cylinders is detected as a rotation signal generation interval for each of the cylinders every time the rotation signal is newly generated, a difference between newly detected rotation signal generation interval for each of the cylinders and previously detected rotation signal generation interval for the same cylinders is calculated as a rotation signal generation interval change amount every time the rotation signal generation interval is detected, and a rotational speed variation amount of the engine is detected on the basis of the rotation signal generation interval change amount.

### TECHNICAL FIELD

The present invention relates to a rotational speed variation amount detecting device that detects a rotational speed variation amount of a multi-cylinder four-cycle engine, and an engine control device that performs control causing the rotational speed of the engine to converge on a target rotational speed while calculating a control gain using the rotational speed variation amount detected by the rotational speed variation amount detecting device.

### BACKGROUND ART

An engine control device, which performs feedback control causing a rotational speed of an engine to converge on a target rotational speed, is provided with, as basic constituent elements, an operating part operated in order to adjust the rotational speed of the engine, a speed deviation calculation part that calculates a deviation between an actual rotational speed of the engine and the target rotational speed, a control gain setting part that sets a control gain, an operation amount calculation part that calculates an operation amount of the operating part needed to cause the rotational speed of the engine to converge on the target rotational speed using the deviation calculated by the speed deviation calculation part and the control gain set by the control gain setting part, and an operating part operation means that operates the operating part by the operation amount calculated by the operation amount calculation part, as is indicated in, for example, patent document 1.

In this type of control device, when the control gain has not been appropriately set, a problem is encountered in that rotational speed overshoot or undershoot occurs when the rotational speed of the engine changes due to load fluctuation, and it takes time for the rotational speed to converge on the target rotational speed. To have rotational speed control be quickly performed, the control gain must be set not to a fixed value but to an appropriate value in accordance with a degree of the rotational speed variation amount.

### PRIOR ART DOCUMENTS

### Patent Documents

Patent Document 1: Japanese Laid-open Patent Application No. 2014-152752

### DISCLOSURE OF THE INVENTION

### Problems to be Solved by the Invention

A widely used method of detecting a rotational speed of the engine is a method in which information on the rotational speed of the engine is obtained by generating an electrical signal having a prescribed waveform as a rotation signal with each rotation of a crankshaft of the engine, and measuring a time interval at which this rotation signal occurs. The rotation signal generated with each rotation of the crankshaft could be, for example, a pulse signal generated from a pulse generator (pick-up coil) attached to the engine, an ignition pulse induced in a primary coil of an ignition coil upon engine ignition, or a rectangle-wave signal or pulse signal indicating a level change when a specific portion (zero-cross point, peak point and the like) is detected in a waveform of AC voltage induced in a generating coil provided within an ignition unit in order to obtain ignition energy.

When the rotational speed is detected by the method described above, a rotational speed variation amount that has occurred while the crankshaft has rotated once can be detected as a degree of the rotational speed variation amount by taking a difference between a currently detected rotational speed and a previously detected rotational speed every time the rotation signals are generated, and a control gain can be set in accordance with the degree of the rotational speed variation amount of the engine by finding the control gain relative to this rotational speed variation amount through map calculation or another method.

With the method described above, the rotational speed variation amount is detected only once while the engine makes one rotation; therefore, when the load of the engine frequently fluctuates, there have been cases in which it is difficult to set the control gain precisely in accordance with the fluctuation in the rotational speed of the engine that accompanies the load fluctuation, and to perform control causing the rotational speed to quickly converge on the target rotational speed.

Particularly, in the case that the engine is a V-type two-cylinder engine in which a first cylinder and a second cylinder are disposed at an angular interval less than 180° (e.g., an angular interval of 90°), an angle of a range from an ignition position of the first cylinder to an ignition position of the second cylinder and an angle of a range from the ignition position of the second cylinder to the ignition position of the first cylinder are different. Therefore, a difference sometimes arises between the rotational speed variation amount occurring while the crankshaft rotates through the range from the ignition position of the first cylinder to the ignition position of the second cylinder and the rotational speed variation amount occurring while the crankshaft rotates through the range from the ignition position of the second cylinder to the ignition position of the first cylinder, but in cases of using the prior-art method in which the rotational speed variation amount of the engine is detected only once while the crankshaft rotates once, there has been a limit on the improvement in the rate of fluctuation of the rotational speed because the difference in these amounts of change in the rotational speed could not be precisely detected and reflected in the control.

Particularly, when the load of the engine is an AC generator that obtains AC voltage at a commercial frequency, an output frequency of the generator must be accurately maintained at a commercial frequency (50 or 60 Hz) and a high-quality AC output having little frequency fluctuation must be obtained; therefore, the control gain must be set with precision in accordance with the fluctuation in the rotational speed of the engine when the rotational speed fluctuates due to load fluctuation in the generator, and it must be possible to cause the rotational speed of the engine to quickly converge on the target rotational speed.

An object of the present invention is to provide an engine rotational speed variation amount detecting device in which the rotational speed variation amount occurring while the crankshaft rotates through a set angular range can be detected at least twice while the crankshaft rotates once, and the rotational speed variation amount can be detected with greater precision than in the prior art.

Another object of the present invention is to provide an engine control device in which control causing the rotational speed of the engine to converge on a target rotational speed can be performed with precision in response to load fluctuations using the aforementioned rotational speed variation amount detecting device.

### Means to Solve the Problems

The present invention is applied to a rotational speed variation amount detecting device that detects a rotational speed variation amount of a multi-cylinder four-cycle engine provided with an engine body having a plurality of cylinders and a crankshaft linked to pistons provided respectively within the plurality of cylinders, and a plurality of ignition units provided correspondingly with respect to each of the plurality of cylinders, the ignition units each being provided with a generating coil that generates AC voltage once per one rotation of the crankshaft, the AC voltage having a waveform in which a first half-wave, a second half-wave of different polarity from the first half-wave, and a third half-wave of the same polarity as the first half-wave appear in the stated order.

The rotational speed variation amount detecting device according to the present invention is provided with: a rotation signal generation means that detects a specific portion of the waveform of the AC voltage outputted by the generating coil provided to the ignition unit corresponding to each of the cylinders, and generates a rotation signal that corresponds to each of the cylinders once per one rotation of the crankshaft; a rotation signal generation interval detection means that, every time the rotation signal generation means generates the rotation signal that corresponds to each of the cylinders, detects, as a rotation signal generation interval for each of the cylinders, an amount of time elapsed from the previous generation to the current generation of the rotation signal that corresponds to each of the cylinders; and a rotation signal generation interval change amount calculation means that, every time the rotation signal generation interval detection means newly detects the rotation signal generation interval for the cylinders, calculates, as a rotation signal generation interval change amount, either a difference between a newly detected rotation signal generation interval for each of the cylinders and a previously detected rotation signal generation interval for the same cylinder or a difference between the newly detected rotation signal generation interval for each of the cylinders and the most recently detected rotation signal generation interval for the other cylinder. And the rotational speed variation amount detecting device is configured so as to detect the rotational speed variation amount of the engine on the basis of the rotation signal generation interval change amount calculated by the rotation signal generation interval change amount calculation means every time the rotation signal generation interval detection means detects the rotation signal generation interval for each of the cylinders.

As described above, when the rotational speed variation amount detecting device is configured so as to detect the rotational speed variation amount of the engine on the basis of the amount of change in the rotation signal generation intervals calculated by the rotation signal generation interval change amount calculation means every time the rotation signal generation interval detection means detects rotation signal generation intervals (amounts of time elapsed from the previous generation to the current generation of rotation signals) for each of the cylinders, the rotational speed variation amount of the engine can be detected a plurality of times during one rotation of the crankshaft, and the rotational speed variation amount of the engine can therefore be detected with greater precision than in the prior art.

The present invention is also applied to an engine control device that performs control causing a rotational speed of a multi-cylinder four-cycle engine to converge on a target rotational speed, the engine being provided with an engine body having a plurality of cylinders and a crankshaft linked to pistons provided respectively within the plurality of cylinders, and a plurality of ignition units provided correspondingly with respect to each of the plurality of cylinders, the ignition units each being provided with a generating coil that generates AC voltage once per one rotation of the crankshaft, the AC voltage having a waveform in which a first half-wave, a second half-wave of different polarity from the first half-wave, and a third half-wave of the same polarity as the first half-wave appear in the stated order.

In the present invention, the engine control device is provided with an operating part operated in order to adjust the rotational speed of the engine, a speed deviation calculation part that calculates a deviation between an actual rotational speed of the engine and the target rotational speed, a rotational speed variation amount detecting device that detects an rotational speed variation amount of the engine that has occurred while the crankshaft rotated through a set angular range, a control gain setting part that sets a control gain in accordance with the rotational speed variation amount detected by the rotational speed variation amount detecting device, an operation amount calculation part that calculates an operation amount of the operating part needed in order to cause the rotational speed of the engine to converge on the target rotational speed using the deviation calculated by the speed deviation calculation part and the control gain set by the control gain setting part, and an operating part drive means that drives the operating part so as to operate the operating part by the operation amount calculated by the operation amount calculation part.

In the present invention, the rotational speed variation amount detecting device is provided with: a rotation signal generation means that detects a specific portion of the waveform of the AC voltage outputted by the generating coil provided to the ignition unit corresponding to each of the cylinders of the engine, and generates a rotation signal that corresponds to each of the cylinders of the engine once per one rotation of the crankshaft; a rotation signal generation interval detection means that, every time the rotation signal generation means generates the rotation signal that corresponds to each of the cylinders, detects, as a rotation signal generation interval for each of the cylinders, an amounts of time elapsed from the previous generation to the current generation of rotation signal that corresponds to each of the cylinders; and a rotation signal generation interval change amount calculation means that, every time the rotation signal generation interval detection means newly detects the rotation signal generation interval for each of the cylinders, calculates, as a rotation signal generation interval change amount, either a difference between a newly detected rotation signal generation interval for each of the cylinders and a previously detected rotation signal generation interval for the same cylinder or a difference between a newly detected rotation signal generation interval for each of the cylinders and the most recently detected rotation signal generation interval for the other cylinder. And the rotational speed variation amount detecting device is configured so as to detect the rotational speed variation amount of the engine on the basis of the rotation signal generation interval change amount calculated by the rotation signal generation interval change amount calculation means every time the rotation signal generation interval detection means detects the rotation signal generation interval for each of the cylinders.

When the engine control device is configured as described above, the rotational speed variation amount that has occurred while the crankshaft of the engine has rotated through a set angular range can be detected a plurality of times while the crankshaft rotates once, and the control gain can be corrected to an appropriate value every time an rotational speed variation amount is detected; therefore, control causing the rotational speed of the engine to converge on the target rotational speed can be performed with precision, the rotational speed of the engine can be caused to quickly converge on the set speed during a load fluctuation, the rate of fluctuation in the rotational speed of the engine can be improved, and the load can be actuated with stability.

Further aspects of the present invention are made clear by the description of the embodiments of the invention, given hereinafter.

### Advantageous Effects of the Invention

The device for detecting a rotational speed variation amount in an engine according to the present invention is provided with: a rotation signal generation means that detects a specific portion of the waveform of the AC voltage outputted by the generating coil provided to each of the ignition units corresponding to each of the cylinders of the engine, and generates a rotation signal that corresponds to the cylinders once per one rotation of the crankshaft; a rotation signal generation interval detection means that detects, as a rotation signal generation interval for each of the cylinders, an amount of time elapsed from the previous generation to the current generation of rotation signal that corresponds to each of the cylinders, every time the rotation signal is generated; and a rotation signal generation interval change amount calculation means that calculates, as a rotation signal generation interval change amount, either a difference between a newly detected rotation signal generation interval for each of the cylinders and a previously detected rotation signal generation interval for the same cylinder or a difference between a newly detected rotation signal generation interval for each of the cylinders and most recently detected rotation signal generation interval for the other cylinder, every time the rotation signal generation interval detection means newly detects a rotation signal generation interval for each of the cylinders; and the rotational speed variation amount detecting device is configured so as to detect the rotational speed variation amount of the engine on the basis of the rotation signal generation interval change amount calculated by the rotation signal generation interval change amount calculation means every time the rotation signal generation interval detection means detects rotation signal generation intervals for the cylinders; therefore, the rotational speed variation amount of the engine can be detected a plurality of times while the crankshaft rotates once, and the rotational speed variation amount of the engine can be detected with greater precision than in the prior art.

With the device for detecting a rotational speed variation amount in an engine according to the present invention, an encoder, a pickup coil, or another special signal generator is not used, a specific portion is detected in the waveform of the AC voltage outputted by the generating coil provided to the ignition unit which is an essential component for actuating the engine, and the generated rotation signal is used to obtain information on the rotational speed of the engine; therefore, the rotational speed variation amount of the engine can be detected without complicating the structure of the engine.

With the engine control device according to the present invention, the rotational speed variation amount that has occurred while the engine made a rotation through the set angular range is detected a plurality of times during one rotation of the engine, and the control gain can be corrected to an appropriate value every time the rotational speed variation amount is detected; therefore, control causing the rotational speed of the engine to converge on the target rotational speed can be performed with higher accuracy than in the prior art, the rate of fluctuation of the rotational speed of the engine can be improved, and the actuation of the load can be stabilized.

In a V-type, two-cylinder, four-cycle engine, it is often the case that different values are observed in the rotational speed variation amount occurring when the crankshaft rotates through a range from the ignition position of the first cylinder to the ignition position of the second cylinder, and the rotational speed variation amount occurring when the crankshaft rotates through a range from the ignition position of the second cylinder to the ignition position of the first cylinder, but in the engine control device according to the present invention, these amounts of change in the rotational speed can be detected individually; therefore, the resolution of the detection of the rotational speed variation amount is increased, control causing the rotational speed to converge on the target rotational speed can be performed with precision, and control causing the rotational speed of the engine to converge on the target rotational speed can be performed with higher accuracy than in the prior art.

### BRIEF DESCRIPTION OF THE DRAWINGS

FIG. 1 is a block diagram schematically showing one example of the configuration of the engine control device according to the present invention;

FIG. 2 is a block diagram showing an example of the configuration of an ignition unit used in the embodiment of FIG. 1;

FIG. 3 is a block diagram showing an example of the configuration of the ignition control part used in the ignition unit shown in FIG. 2;

FIG. 4 is a waveform chart showing a waveform of voltage induced in a generating coil provided to a generator used in an embodiment of the present invention, and a waveform of rectangular-wave voltage generated using this voltage waveform;

FIG. 5 is a block diagram schematically showing a configuration of one embodiment of the engine control device according to the present invention and a rotational speed variation amount detecting device used in this control device;

FIG. 6 is a block diagram schematically showing an example of the configuration of the rotational speed variation amount detecting device according to the present invention;

FIG. 7 is a block diagram schematically showing another configuration example of the rotational speed variation amount detecting device according to the present invention;

FIG. 8 is a waveform chart showing a waveform of the first rotation signal S1 generated by detecting a portion of an ignition pulse induced in a primary coil of an ignition coil of the ignition device of the first cylinder of the engine shown in FIG. 1, and a waveform of the second rotation signal S2 generated by detecting a portion of an ignition pulse induced in a primary coil of an ignition coil of the ignition device of the second cylinder of the same engine, these waveforms being shown in relation to a rotational angle of a crankshaft;

FIG. 9 is a flowchart showing an example of an algorithm of a process repeatedly performed by a CPU in an infinitesimal time interval, in order to perform control causing a rotational speed of the engine to converge on a set speed when the rotational speed of the engine has fluctuated;

FIG. 10 is a flowchart showing an algorithm of an S1 interruption process performed by the CPU every time a first rotation signal S1 is generated at an ignition position of the first cylinder of the engine, when the rotational speed variation amount detecting device is configured as shown in FIG. 6;

FIG. 11 is a flowchart showing an algorithm of an S2 interruption process performed every time a second rotation signal S2 is generated at an ignition position of the second cylinder of the engine, when the rotational speed variation amount detecting device is configured as shown in FIG. 6;

FIG. 12 is a flowchart showing the algorithm of the S1 interruption process performed every time the first rotation signal S1 is generated at the ignition position of the first cylinder of the engine, when the rotational speed variation amount detecting device is configured as shown in FIG. 7; and

FIG. 13 is a flowchart showing the algorithm of the S2 interruption process performed every time the second rotation signal S2 is generated at the ignition position of the second cylinder of the engine, when the rotational speed variation amount detecting device is configured as shown in FIG. 7.

### EMBODIMENTS FOR CARRYING OUT THE INVENTION

Embodiments of the present invention are described in detail below with reference to the drawings.

The present invention can be applied to a multi-cylinder four-cycle engine having n (n is an integer of 2 or greater) cylinders. In the embodiments presented below, the engine is a V-type two-cylinder four-cycle engine.

In a four-cycle engine, spark discharge is caused by a spark plug attached to a cylinder of the engine at a regular ignition position set near a crank angle position (rotational position of a crankshaft of the engine) at which a piston in the cylinder reaches top dead center in a compression stroke, and fuel is caused to combust inside the cylinder once with every two rotations of the crankshaft. Therefore, an ignition device is preferably caused to perform an ignition action once with every two rotations of the crankshaft in order to cause the engine to rotate. To cause the ignition action to be performed once with every two rotations of the crankshaft, a stroke determination must be performed to determine whether the stroke ending when the piston reaches top dead center is a compression stroke or an exhaust stroke. Therefore, a camshaft sensor or another special sensor that generates a signal once with every two rotations of the crankshaft must be attached to the engine. However, a structure of the engine becomes complicated when the special sensor is attached to the engine. Therefore, ignition devices are often configured such that the ignition action is allowed to be performed even in a final stage of the exhaust stroke, and the ignition action is performed near a crank angle position at which the piston reaches top dead center with every rotation of the crankshaft. In the embodiments presented below, the present invention is applied to a one-firing-per one rotation, multi-cylinder, four-cycle engine in which the ignition action is performed with every rotation of the crankshaft.

The term “ignition action” in the present specification means an action in which a high voltage is applied from a secondary coil of an ignition coil provided to the ignition device to spark plug attached to the cylinder of the engine, and spark discharge is caused in the spark plug of the cylinder. This term incorporates both an irregular ignition action performed at a crank angle position near the final stage of the exhaust stroke, and a regular ignition action performed at a crank angle position near the final stage of the compression stroke. The spark caused by the irregular ignition action performed at a crank angle position near the final stage of the exhaust stroke is considered to be a wasteful ignition.

In the present specification, the term “ignition period” or “ignition position” is used where appropriate, with “ignition period” meaning a timing (point in time) at which ignition is performed, and “ignition position” meaning a crank angle position (rotational position of the crankshaft) at which ignition is performed. In the description of the configuration and actions of the present invention, the term “ignition period” is used when the time at which the ignition action is performed is an issue and the term “ignition period” is used when the crank angle position at which the ignition action is performed is an issue.

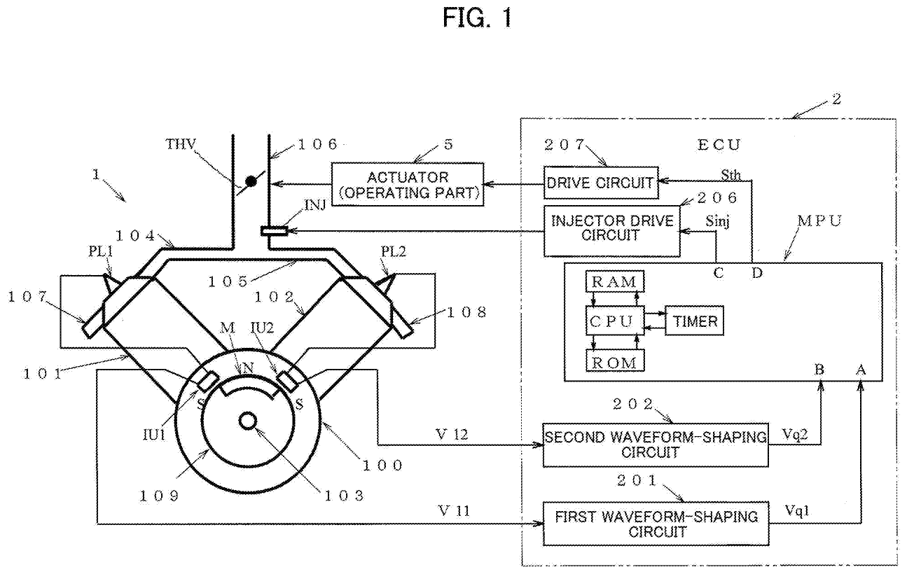

FIG. 1 shows one configuration example of an engine control device according to the present invention. In this diagram, the reference number 1 indicates an engine, and the reference number 2 indicates an electronic control unit (ECU) constituting a main part of an engine control device that controls the engine 1. The engine 1 is provided with: an engine body having a crank case 100, a first cylinder 101 and second cylinder 102, a crankshaft 103 supported on the crank case 100, and first and second pistons (not shown) disposed in the first cylinder and second cylinder and linked to the crankshaft 103 via connecting rods; and first and second ignition units IU1 and IU2 provided to correspond respectively to the first cylinder 101 and the second cylinder 102.

Provided at head parts of the first cylinder 101 and the second cylinder 102 are intake ports opened and closed by intake valves, and exhaust ports opened and closed by exhaust valves. The intake ports of the first cylinder 101 and the second cylinder 102 are connected to a throttle body 106 via intake manifolds 104 and 105, respectively, and the exhaust ports of the first cylinder 101 and the second cylinder 102 are connected to an exhaust pipe (not shown) via exhaust manifolds 107 and 108, respectively. In the illustrated example, an injector (fuel injection valve) INJ is attached to the throttle body 106, and fuel is injected from the injector INJ into a space inside the throttle body 106. A throttle valve THV constituting an operating part, which is operated when a rotational speed of the engine is adjusted is attached to the throttle body 106 upstream of the injector INJ. The throttle valve THV is operated by an actuator 5 composed of a stepping motor, etc.

A first spark plug PL1 and a second spark plug PL2 are respectively attached to the head part of the first cylinder 101 and the head part of the second cylinder 102, and discharge gaps in these spark plugs are inserted into combustion chambers inside the first cylinder 101 and the second cylinder 102.

The V-type two-cylinder four-cycle engine shown in FIG. 1 has a structure in which the first cylinder 101 and the second cylinder 102 are disposed in a V formation, in a state such that the first cylinder 101 is positioned apart from the position of the second cylinder 102 by an angle β° (0<β<180) forward in a direction of forward crankshaft rotation (counterclockwise in the plane of the drawing of FIG. 1). In the present embodiment, β=90.

A flywheel 109 is attached to one end of the crankshaft 103, and a permanent magnet is attached to an outer periphery of the flywheel 109, whereby a magnetic rotor M is configured having a three-pole magnetic pole part in which S poles are formed on both sides of an N pole. The first ignition unit IU1 and the second ignition unit IU2, provided respectively for the first cylinder 101 and the second cylinder 102 of the engine, are disposed on an outer side of the flywheel 109. The first ignition unit IU1 and the second ignition unit IU2 constitute main parts of ignition devices that ignite the first cylinder 101 and the second cylinder 102, respectively. These ignition units are disposed at positions suitable for causing the ignition action to be performed in the corresponding cylinder and secured to ignition unit attachment parts provided to a case, a cover, etc., of the engine. In the illustrated example, the first ignition unit IU1 is disposed at a position apart from the position of the second ignition unit IU2 by an angular interval of 90° forward in the direction of forward crankshaft rotation. A flywheel magnet is configured by the magnetic rotor M and the ignition units IU1 and IU2.

The ignition units IU1, IU2 are each formed into a unit by having a case accommodate the following: an armature core having at both ends a magnetic pole part facing the magnetic poles of the magnetic rotor M with gaps interposed therebetween; an ignition coil provided with a primary coil and a secondary coil wound as generating coils around the armature core; a constituent element of a primary current control circuit that controls a primary current of the ignition coil so as to induce a high voltage for ignition in the secondary coil of the ignition coil during the ignition period of the engine; and a microprocessor or other constituent element constituting a control means that controls the primary current control circuit.

The primary current control circuit is a circuit that causes a rapid change in the primary current of the ignition coil at the ignition timing of the engine, and induces a high voltage for ignition in the secondary coil of the ignition coil. A capacitor discharge circuit and a current-blocking circuit are known as examples of primary current control circuits. In the present embodiment, a current-blocking circuit is used as the primary current control circuit.

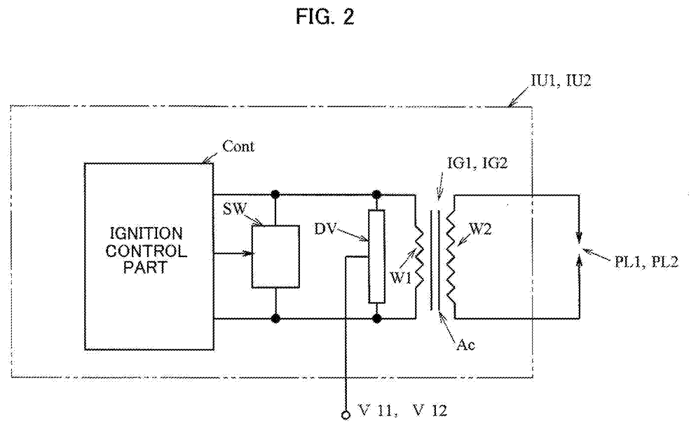

Referring to FIG. 2, an example of a configuration of the ignition units IU1 and IU2 used in the present embodiment is shown. In FIG. 2, reference symbols IG1 and IG2 indicate first and second ignition coils provided correspondingly with respect to each of the first cylinder and second cylinder of the engine. The ignition coils are each composed of an armature core Ac, and a primary coil W1 and a secondary coil W2 wound as generating coils around the armature core Ac. The letters SW indicate a primary current control switch connected in parallel to the primary coil W1, the letters Cont indicate an ignition control part, and the letters DV indicate a voltage detection circuit that detects voltage at both ends of the primary coil W1.

The primary current control switch SW is configured from a transistor, a MOSFET, or another semiconductor switch element, and is put into an ON state by the sending of a drive signal from the primary coil W1 side when a voltage of a predetermined polarity has been induced in the primary coil W1 of the ignition coil.

The voltage detection circuit DV is configured from a resistance-voltage-dividing circuit, etc., connected in parallel to both ends of the primary coil W1 of the ignition coil. The voltage detection circuit DV detects voltages (primary voltages) across the primary coils of the ignition coils of the ignition units IU1 and IU2 and outputs primary voltage detection signals V11 and V12 during the ignition period

of the first cylinder and the second cylinder. The primary voltage detection signal V11 outputted from the voltage detection circuit DV of the first ignition unit IU1 and the primary voltage detection signal V12 outputted from the voltage detection circuit DV of the second ignition unit IU2 are sent to the electronic control unit 2 shown in FIG. 1.

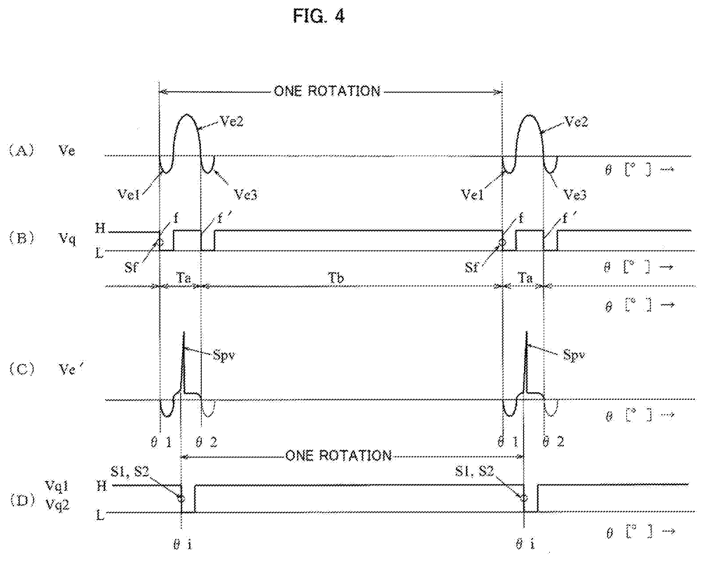

When three magnetic poles are provided to the magnetic rotor M, an AC voltage Ve is generated once per one rotation of the crankshaft in the primary coils W1 of the ignition coils IG provided to the ignition units IU1, IU2, this AC voltage Ve having a waveform in which a first half-wave voltage Ve1, a second half-wave voltage Ve2 of reverse polarity (positive polarity in the illustrated example) to the first half-wave voltage Ve1, and a third half-wave voltage Ve3 of the same polarity (negative polarity in the illustrated example) as the first half-wave voltage Ve1 appear in the stated order as shown in FIG. 4(A). In the present embodiment, the voltage induced in the primary coil of the ignition coil of the first ignition unit IU1 and the voltage induced in the primary coil of the ignition coil of the second ignition unit IU2 have a phase difference of 90° at a mechanical angle. The horizontal axis in FIG. 4 represents a rotational angle θ of the crankshaft.

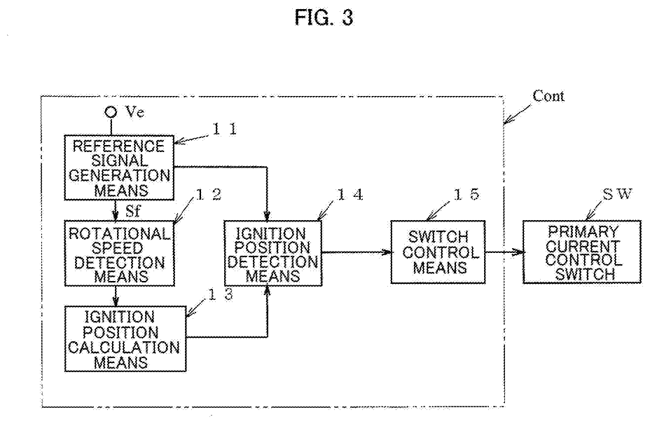

The ignition control part Cont shown in FIG. 2 is configured from, for example, a reference signal generation means 11 that generates a reference signal Sf, a rotational speed detection means 12, an ignition position calculation means 13, an ignition position detection means 14, and a switch control means 15, as shown in FIG. 3.

Commonly, in an ignition device for an engine, the rotational speed of the engine is detected, the ignition position θi of the engine is calculated relative to the detected rotational speed, and a high voltage for ignition is applied to the spark plug when the calculated ignition position has been detected, causing an ignition action to be performed.

To enable the ignition position θi to be detected, a reference position is set to a crank angle position advanced further past a maximum advance position of the ignition position of the engine, the reference signal Sf is caused to be generated at this reference position, and when this reference signal is generated, an ignition timer is set to the amount of time needed for the crankshaft to rotate from the reference position to the ignition position as a measurement time for ignition position detection, and measurement of this amount of time is initiated. When the measurement of the measurement time set to the ignition timer is completed, the primary current control switch SW is set to an OFF state and the ignition action is performed. In the present embodiment, a position θ1 where the first half-wave voltage Ve1 is generated, of the parts of the waveform of the voltage Ve induced in the primary coil of the ignition coil, is set as a reference position and the reference signal Sf is generated at this reference position θ1.

The reference signal generation means 11 shown in FIG. 3 can be configured from, for example, a waveform-shaping circuit that converts the voltage Ve induced in the primary coil of the ignition coil provided to each of the ignition units IU1, IU2 to a voltage Vq having a rectangular waveform such as is shown in FIG. 4(B), and a signal identification means that performs a signal process for identifying, as the reference signal Sf, a fall f that, among falls f, f′, . . . in the rectangular-wave voltage Vq, occurs at the crank angle position where the first half-wave voltage Ve1 of the voltage Ve induced in the primary coil of the ignition coil occurs.

The signal identification means that identifies the reference signal Sf can be configured, for example, so as to measure the intervals at which the falls f, f′, . . . in the rectangular-wave voltage Vq occur, and to identify, as the reference signal Sf, the fall f occurring at the start of the time period of the first half-wave voltage Ve1, making use of the fact that the relationship Ta<<Tb exists between a time Ta that elapsed from the fall f until the fall f′ occurring immediately thereafter, and a time Tb that elapsed from the fall f′ until the next fall f.

The rotational speed detection means 12 shown in FIG. 3 is a means that detects the rotational speed of the engine, this means detecting, for example, the rotational speed of the crankshaft from the cycle in which the reference signal Sf occurs (the amount of time for the crankshaft to make one rotation).

The ignition position calculation means 13 is a means that calculates the ignition position θi at the rotational speed detected by the rotational speed detection means 12. The ignition position calculation means 13 calculates measurement values (measurement times for ignition position detection) measured by the ignition timer in order to detect the ignition position at each rotational speed of the engine, by, for example, conducting an interpolative calculation on a value obtained by searching an ignition position calculation map for the rotational speed detected by the rotational speed detection means 12.

The software-based processes needed to constitute the reference signal generation means 11, the rotational speed detection means 12, the ignition position calculation means 13, and the ignition position detection means 14 are performed by microprocessors provided inside the ignition units IU1, IU2.

The primary current control switches SW provided to the ignition units IU1, IU2 are put into an ON state due to a drive signal being sent by the second half-wave voltage Ve2 when this voltage Ve2 is induced in the primary coil of the ignition coil in each unit, and a short-circuit current is flowed to the primary coil of the ignition coil.

When the reference signal generation means 11 in each of the ignition units IU1, IU2 has generated the reference signal Sf, the ignition position detection means 14 provided to each of the ignition units sets the ignition timer to an amount of time to be measured by the ignition timer in order to detect the ignition position, initiates measurement of the set amount of time, and sends an ignition command to the switch control means 15 of each of the ignition units when the ignition timer completed measurement of the set amount of time.

The switch control means 15 of each of the ignition units is a means that puts the primary current control switch SW of the respective ignition unit into an OFF state when an ignition command has been sent from the ignition position detection means 14. This means is configured from, for example, a means that bypasses the drive signal sent to the primary current control switch SW inside the respective ignition unit, the means bypassing the signal from the primary current control switch.

In each of the ignition units, when the switch control means 15 bypasses from the primary current control switch SW the drive signal sent to the switch SW, the primary current control switch SW is put into an OFF state, and the primary current of the ignition coil is blocked. At this time, a high voltage oriented toward causing the primary current that had been heretofore flowing to continue to flow is induced in the primary coil of the ignition coil. This voltage is boosted by a boosting ratio between the primary and secondary coils of the ignition coil, and a high voltage for ignition is therefore induced in the secondary coil of the ignition coil of each of the ignition units. The high voltages for ignition induced in the secondary coils of the ignition coils provided respectively to the ignition units IU1 and IU2 are applied respectively to the spark plugs PL1 and PL2, spark discharge therefore occurs in the spark plugs, and the engine is ignited.

When the primary current control switch SW is put into the OFF state to induce the high voltage for ignition in the secondary coil of the ignition coil, a pulse-form spike voltage (ignition pulse) Spy is induced in the primary coil of the ignition coil as shown in FIG. 4(C). With each rotation of the crankshaft of the engine, this ignition pulse occurs once in the primary coil of the ignition coil in each of the ignition units at the ignition position (the position where the ignition action is performed) set near the final stage of the compression stroke of the engine or near the final stage of the exhaust stroke.

The electronic control unit (ECU) 2 shown in FIG. 1 is provided with: a microprocessor MPU having a CPU (central computing/processing device), ROM (read-only memory), RAM (random-access memory), a timer, etc.; first and second waveform-shaping circuits 201 and 202 that convert the primary voltage detection signals V12 and V12 to rectangular-wave voltages Vq1 and Vq1, the primary voltage detection signals V12 and V12 being respectively outputted from the primary voltage detection circuit DV in the first ignition unit IU1 and the primary voltage detection circuit DV in the second ignition unit IU2, and sending the rectangular-wave voltages Vq1 and Vq1 to ports A and B of the microprocessor MPU; an injector drive circuit 206 that receives as input an injection command signal Sinj outputted by the MPU from a port C, and sends a drive voltage Vinj having a rectangular waveform to the injector INJ in order to cause a predetermined fuel to be injected from the injector INJ; and a drive circuit 207 that receives as input a throttle drive command Sth outputted by the MPU from a port D, and sends a drive voltage to the actuator 5 which operates the throttle valve THV.

The primary voltage detection signals V12 and V12 respectively outputted from the primary voltage detection circuit DV (see FIG. 2) in the first ignition unit IU1 and the primary voltage detection circuit DV in the second ignition unit IU2 have waveforms similar to the waveform (see FIG. 4A) of the AC voltage Ve induced in the primary coil of the ignition coils IG in each of the units. The first and the second waveform-shaping circuits 201 and 202 shown in FIG. 1 respectively convert the primary voltage detection signal V11 outputted from the primary voltage detection circuit DV in the first ignition unit IU1 and the primary voltage detection signal V12 outputted from the primary voltage detection circuit DV in the second ignition unit IU2 to rectangular-wave voltages Vq1 and Vq2 such as, for example, those shown in FIG. 4(D). The depicted rectangular-wave voltages Vq1 and Vq2 are, respectively, signals that fall from an H level to an L level when the ignition pulse Spy has been induced in the primary coils of the ignition coils in the ignition units IU1, IU2, and thereafter return from the L level to the H level when a certain amount of time has elapsed. These rectangular-wave voltages Vq1 and Vq2 are respectively inputted to the ports A and B of the microprocessor MPU. The microprocessor MPU recognizes that rotation signals S1 and S2 have been generated in response to the falling of the rectangular-wave voltages Vq1 and Vq2 from the H level to the L level.

The waveform-shaping circuits 201, 202 can be configured from, for example, a circuit designed to obtain a rectangular-wave signal at a collector of the transistor provided so as to go into an ON state upon being sent a base current while the voltage at both ends of the primary coil of the corresponding ignition coil is equal to or greater than a threshold value, or a monostable multivibrator that is triggered by an ignition pulse equal to or greater than a threshold value to generate a rectangular-wave pulse having a constant pulse width.

In the present embodiment, a rotor of an AC generator (not shown in FIG. 1), which is a main load of the engine, is linked to the other end of the crankshaft 103, positioned on the reverse side of the plane of the drawing in FIG. 1, and an engine generator that generates AC voltage at a commercial frequency is configured by this AC generator and the engine 1.

In an engine generator that generates an AC voltage at a commercial frequency, an output frequency of the engine must be kept constant; therefore, when a load of the generator fluctuates and a rotational speed of the engine fluctuates, control must be quickly performed to cause the rotational speed of the engine to converge on a target rotational speed. To quickly perform control on the rotational speed of the engine, a control gain multiplied by a deviation between the actual rotation speed of the engine and the target rotational speed must be set not to a fixed value, but to a value that is appropriate according to an rotational speed variation amount of the engine (a degree of the change in the rotational speed of the engine) that occurs while the crankshaft is rotating through a set angular range.

In the present embodiment, control of the ignition period of the engine is performed by the ignition control parts Cont built into the first ignition unit IU1 and the second ignition unit IU2. The electronic control unit 2 is used to perform control of the injector (fuel injection valve) that supplies fuel to the engine, and control that causes the rotational speed of the engine to converge on the target rotational speed when the rotational speed of the engine has fluctuated due to load fluctuation in the generator.

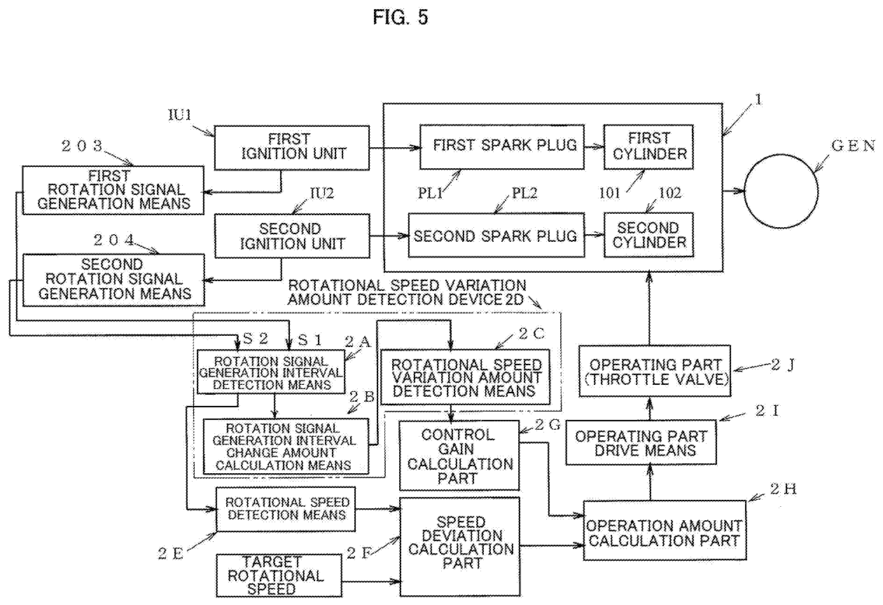

Referring to FIG. 5, this diagram shows a configuration of one embodiment of an engine control device according to the present invention and a rotational speed variation amount detecting device used in this control device. In FIG. 5, the number 1 indicates the V-type two-cylinder four-cycle engine shown in FIG. 1, this engine having the first cylinder 101 and the second cylinder 102, and the first spark plug PL1 and second spark plug PL2 being respectively attached to the first cylinder 101 and the second cylinder 102. Additionally, a rotor of an AC generator GEN that induces AC voltage at a commercial frequency is connected to the crankshaft of this engine.

The IU1 and IU2 are respectively a first ignition unit and a second ignition unit provided for the first cylinder 101 and the second cylinder 102, and an AC voltage Ve having a waveform in which a first half-wave Ve1, a second half-wave Ve2 of different polarity from the first half-wave, and a third half-wave Ve3 of the same polarity as the first half-wave appear in the stated order, as shown in FIG. 4(A), occurs once per one rotation of the crankshaft in the primary coils of the ignition coils provided within the first and second ignition units IU1 and IU2.

In FIG. 5: the number 203 indicates a first rotation signal generation means that detects a specific portion (the ignition pulse Spy in the present embodiment) of the waveform of the AC voltage outputted by the generating coil provided to the ignition unit IU1 that causes ignition in the first cylinder 101 of the engine, and generates a first rotation signal S1 corresponding to the first cylinder once per one rotation of the crankshaft; and the number 204 indicates a second rotation signal generation means that detects a specific portion (the ignition pulse Spy in the present embodiment) of the waveform of the AC voltage outputted by the generating coil provided to the ignition unit IU2 corresponding to the second cylinder 102, and generates a rotation signal S2 corresponding to the second cylinder once per one rotation of the crankshaft.

In the present embodiment, the first rotation signal generation means 203 that detects a specific portion of the waveform of the primary voltage of the first ignition coil IG1 and generates the rotation signal S1 for the first cylinder is configured from the first waveform-shaping circuit 201 shown in FIG. 1 and steps executed by the microprocessor MPU to recognize, as the first rotation signal S1 for the first cylinder, the fall in the rectangular-wave voltage Vq1 outputted from this waveform-shaping circuit 201. The second rotation signal generation means 204 that detects a specific portion of the waveform of the primary voltage of the second ignition coil IG2 and generates the rotation signal S2 for the second cylinder is configured from the second waveform-shaping circuit 202 shown in FIG. 1 and steps executed by the microprocessor MPU to recognize, as the rotation signal S2 for the second cylinder, the fall in the rectangular-wave voltage Vq2 outputted from this waveform-shaping circuit.

In the example shown in FIG. 5, a rotation signal generation interval detection means 2A, a rotation signal generation interval change amount calculation means 2B, and a rotational speed variation amount detection means 2C are provided, and a rotational speed variation amount detecting device 2D that detects the rotational speed variation amount of the engine is configured from these means.

More specifically, the rotation signal generation interval detection means 2A is a means that detects as a signal generation interval for the cylinders, an amount of time elapsed from the previous generation of a rotation signal that corresponds to each of the cylinders to the current generation of a rotation signal that corresponds to each of the cylinders, every time the rotation signal generation means 203, 204 generate rotation signals that correspond to the cylinders. The rotation signal generation interval(time interval) for the first cylinder 101 and the rotation signal generation interval for the second cylinder 102 are amounts of time needed for the crankshaft to rotate once, and information on the rotational speed of the crankshaft can therefore be obtained from both of these rotation signal generation intervals.

The rotation signal generation interval change amount calculation means 2B is a means that calculates, as a rotation signal generation interval change amount every time the rotation signal generation interval detection means newly detects the rotation signal generation interval for each of the cylinders, either a difference between the newly detected rotation signal generation interval for each of the cylinders and the previously detected rotation signal generation interval for the same cylinder, or a difference between a newly detected rotation signal generation interval for each of the cylinders and the previously detected rotation signal generation interval for the other cylinder. The rotational speed variation amount detection means 2C is a means that detects the rotational speed variation amount of the engine, which occurred while the crankshaft rotated through a set angular range, the set angular range being 360 degrees in the present embodiment, on the basis of a rotation signal generation interval change amount calculated by the rotation signal generation interval change amount calculation means 2B every time the rotation signal generation interval detection means 2A detects the rotation signal generation interval for each of the cylinders.

In FIG. 5, reference symbol 2E indicates a rotational speed detection means that obtains information on the actual rotational speed of the engine on the basis of the rotation signal generation interval detected by the rotation signal generation interval detection means 2A, reference symbol 2F indicates a speed deviation calculation part that calculates a deviation between the actual rotational speed of the engine detected by the rotational speed detection means 2E and the target rotational speed needed to make an output frequency of the generator GEN be equal to a set commercial frequency, and reference symbol 2G indicates a control gain calculation part that calculates a control gain G relative to the rotational speed variation amount detected by the rotational speed variation amount detection means 2C.

The control gain calculation part 2G can be configured so as to calculate the control gain by searching a control gain calculation map for parameters including information on the rotational speed variation amount. As is well known, control gains used in feedback control are proportional gain, integral gain, and differential gain. Of these control gain, proportional gain must always be calculated, and integral gain and differential gain are calculated only when there are an integral term and a differential term in a calculation formula for finding an operation amount.

In the engine control device according to the present invention, a control gain is calculated for at least the parameter including information on the rotational speed variation amount of the engine, but there is nothing hindering the use of the other parameter such as a target rotational speed in addition to the parameter including information on the rotational speed variation amount as the parameter used when the control gain is calculated.

In FIG. 5, reference symbol 2H indicates an operation amount calculation part that multiplies the control gain G calculated by the control gain calculation part 2G by the speed deviation calculated by the speed deviation calculation part 2F to calculate a requisite operation amount by which an operating part is operated to cause the rotational speed of the engine to converge on the target rotational speed, and reference symbol 2I indicates an operating part drive means that drives an operating part 2J so that the operating part is operated by the operation amount calculated by the operation amount calculation part 2H.

In the present embodiment, the operating part 2J is configured from the throttle valve THV, and the operating part drive means 21 is configured from the drive circuit 207 shown in FIG. 1. Of the components shown in FIG. 5: the rotation signal generation interval detection means 2A, the rotation signal generation interval change amount calculation means 2B, and the rotational speed variation amount detection means 2C constituting the rotational speed variation amount detecting device 2D; the rotational speed detection means 2E; the speed deviation calculation part 2F; the control gain calculation part 2G; and the operation amount calculation part 2H are configured by causing the CPU to execute predetermined programs stored in the ROM of the MPU shown in FIG. 1.

When the present invention is carried out, the data indicating the rotational speed of the engine may be the rotation signal generation intervals (time intervals) alone, or the data may be the rotational speed of the engine found from the rotation signal generation intervals and the rotational angle from the previous ignition position to the current ignition position.

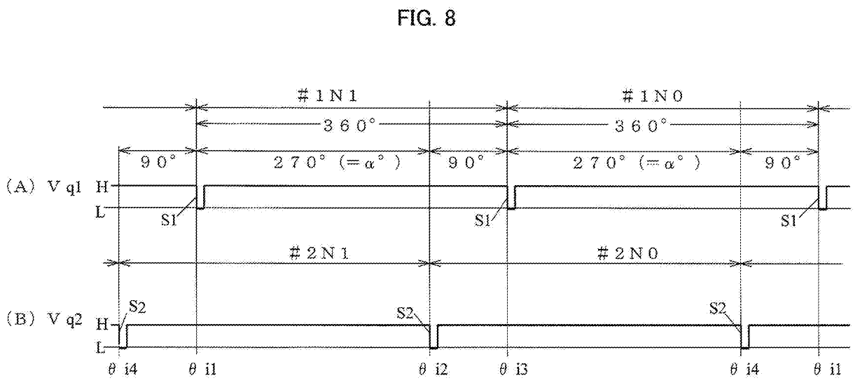

In the V-type two-cylinder four-cycle engine shown in FIG. 1, while the crankshaft 103 rotates 720°, the ignition action in the first cylinder 101 is performed at a first crank angle position θi1, after which the ignition action in the second cylinder is performed at a second crank angle position θi2 distanced a certain angle α° (≤360°) from the first crank angle position θi1, and the ignition action in the first cylinder is performed at a third crank angle position θi3 distanced a certain angle (360−α°) from the second crank angle position θi2, after which the ignition action in the second cylinder is performed at a fourth crank angle position θi4 distanced a certain angle α° from the third crank angle position θi3, as shown in FIG. 8. In the present embodiment, α°=270°, and (360−α)°=90°. The ignition action in the first cylinder performed at the first crank angle position θi1 and the ignition action in the second cylinder performed at the second crank angle position θi2 are regular ignition actions that contribute to fuel combustion in the first cylinder and in the second cylinder, respectively, ignition action in the first cylinder performed at the third crank angle position θi3 and the ignition action in the second cylinder performed at the fourth crank angle position θi4 are irregular ignition actions that do not contribute to fuel combustion.

The first rotation signal generation means 203 shown in FIG. 5 generates the first rotation signal S1 when the ignition action in the first cylinder 101 is performed at the first crank angle position θi1 and the third crank angle position θi3, and the second rotation signal generation means 204 generates the second rotation signal S2 when the ignition action in the second cylinder 102 is performed at the second crank angle position θi2 and the fourth crank angle position θi4.

Every time the first rotation signal generation means 203 and the second rotation signal generation means 204 respectively generate the first rotation signal S1 corresponding to the first cylinder and the second rotation signal S2 corresponding to the second cylinder, the rotation signal generation interval detection means 2A shown in FIG. 5 reads a measurement value of a free-run timer provided to the microprocessor and detects, as the rotation signal generation interval for the first cylinder and the rotation signal generation interval for the second cylinder, the amounts of time elapsed from the previous generation to the current generation of the first rotation signal S and the second rotation signal S2 correspondingly with respect to each of the first cylinder and the second cylinder.

In FIG. 8, reference symbol #1N1 indicates a rotation signal generation interval for the first cylinder measured by a timer while the crankshaft rotates from the first crank angle position θi1 to the third crank angle position θi3, and reference symbol #1N0 indicates a rotation signal generation interval for the first cylinder measured by a timer while the crankshaft rotates from the third crank angle position θi3 to the first crank angle position θi1. Additionally, reference symbol #2N1 indicates a rotation signal generation interval for the second cylinder measured by a timer while the crankshaft rotates from the fourth crank angle position θi4 to the second crank angle position θi2, and reference symbol #2N0 indicates a rotation signal generation interval for the second cylinder measured by a timer while the crankshaft rotates from the second crank angle position θi2 to the fourth crank angle position θi4.

In FIG. 8, when #1N0 is the newest (current) measurement value of the rotation signal generation interval for the first cylinder, #1N1 is the previous measurement value of the rotation signal generation interval for the first cylinder. Additionally, when #2N0 is the newest measurement value of the rotation signal generation interval for the second cylinder, #2N1 is the previous measurement value of the rotation signal generation interval for the second cylinder.

In FIG. 8, #1N1 is the amount of time needed for the crankshaft to rotate through a 360° range from the first crank angle position θi1 to the third crank angle position θi3, and therefore includes information on an average rotational speed of the crankshaft while the crankshaft rotates through the 360° range from the first crank angle position θi to the third crank angle position θi3. Additionally, #1N0 is the amount of time needed for the crankshaft to rotate through a 360° range from the third crank angle position θi3 to the first crank angle position θi1, and therefore includes information on the average rotational speed of the crankshaft while the crankshaft rotates through the 360° range from the third crank angle position θi3 to the first crank angle position θi1. Therefore, when an absolute value |#1N0−#1N1| of a difference between the newly detected rotation signal generation interval #1N0 and the previously detected rotation signal generation interval #1N1 is found as the amount of change in the rotation signal generation interval, information on the rotational speed variation amount that has occurred while the crankshaft rotated through the 360° range can be obtained from this amount of change in the rotation signal generation interval.

Similarly, #2N1 includes information on the average rotational speed of the crankshaft while the crankshaft rotates through a 360° range from the fourth crank angle position θi4 to the second crank angle position θi2, and #2N0 includes information on the average rotational speed of the crankshaft while the crankshaft rotates through a 360° range from the second crank angle position θi2 to the fourth crank angle position θi4. Therefore, when an absolute value |#2N0−#2N1| of a difference between the newly detected rotation signal generation interval #2N0 and the previously detected rotation signal generation interval #2N1 is found as the amount of change in the rotation signal generation interval, information on the rotational speed variation amount that has occurred while the crankshaft rotated through the 360° range can be obtained from the value of this amount of change in the rotation signal generation interval.

Every time the rotation signal generation interval detection means 2A detects rotation signal generation intervals for each of the cylinders, the rotational speed variation amount detection means 2C shown in FIG. 5 detects an rotational speed variation amount of the engine that has occurred while the crankshaft rotated through a set angular range on the basis of the amounts of change in the rotation signal generation intervals calculated by the rotation signal generation interval change amount calculation means 2B; therefore, the rotational speed variation amount that has occurred while the crankshaft rotated through a set angular range can be detected a number of times equal to the number of cylinders in the engine while the crankshaft rotates once, and the rotational speed variation amount of the engine can be detected with greater precision than in the prior art. Therefore, the control gain can be set with precision in accordance with the degree of fluctuation in the rotational speed of the engine, and control causing the rotational speed of the engine to converge on the target rotational speed can be performed quickly.

When the first cylinder and the second cylinder are disposed at an angular interval less than 180° (an angular interval of 90° in the present embodiment) as in the engine used in the present embodiment, the angle (270° in the present embodiment) of the range from the ignition position of the first cylinder to the ignition position of the second cylinder and the angle (90° in the present embodiment) from the ignition position of the second cylinder to the ignition position of the first cylinder are different. Therefore, a difference arises between the rotational speed variation amount occurring while the crankshaft rotates through the range from the ignition position of the first cylinder to the ignition position of the second cylinder, and the rotational speed variation amount occurring while the crankshaft rotates through the range from the ignition position of the second cylinder to the ignition position of the first cylinder. However, in the present embodiment, the rotational speed variation amount can be detected twice while the crankshaft rotates once; therefore, the rotational speed variation amount of the engine can be precisely detected and the control gain can be appropriately set.

In the above description, the difference between the newly detected rotation signal generation intervals for each of the cylinders and the previously detected rotation signal generation intervals for each of the cylinders is found as the amount of change in the rotation signal generation intervals, and the rotational speed variation amount occurring while the crankshaft rotates through a set angular (360° in the present embodiment) range is detected from this amount of change in the rotation signal generation intervals, but another possible option is that the difference between the rotation signal generation interval for each cylinder newly detected by the rotation signal generation interval detection means and the most recent previously detected rotation signal generation interval for the other cylinder be calculated as the amount of change in the rotation signal generation intervals, and the rotational speed variation amount occurring while the crankshaft rotates through a set angular range be detected from this amount of change in the rotation signal generation intervals.

For example, in FIG. 8, when the rotation signal generation interval #1N0 for the first cylinder has been detected and an absolute value |#1N0−#2N0| of a difference between this rotation signal generation interval and the most recent previously detected rotation signal generation interval #2N0 for the second cylinder is found as the amount of change in the rotation signal generation interval, information can be obtained on the amount of fluctuation in the rotational speed that has occurred while the crankshaft rotated through a 90° (=360°−α°) range from the fourth crank angle position 814 to the first crank angle position 611, and information on the rotational speed variation amount that has occurred while the crankshaft rotated 360° can be obtained by performing the calculation |#1N0−#2N0|×(360/90) and converting the amount of change in the rotation signal generation interval to an amount of change in the rotation signal generation interval that has occurred while the crankshaft rotated 360°.

Similarly, when the rotation signal generation interval #2N0 for the second cylinder has been detected and an absolute value |#2N0−#1N0| of a difference with the most recent previously detected rotation signal generation interval #1N1 for the first cylinder is found as the amount of change in the rotation signal generation interval, information can be obtained on the rotational speed variation amount that has occurred while the crankshaft rotated through a 270° (=α°) range from the third crank angle position θi3 to the fourth crank angle position θi4, and information on the rotational speed variation amount that has occurred while the crankshaft rotated 360° can be obtained by performing the calculation |#2N0−#1N1|×(360/270) and converting the amount of change in the rotation signal generation interval that has occurred while the crankshaft rotated through the 270° range to the amount of change in the rotation signal generation interval that has occurred while the crankshaft rotated 360°.

Thus, when the difference between the rotation signal generation interval for each cylinder newly detected by the rotation signal generation interval detection means and the most recent previously detected rotation signal generation interval for the other cylinder is calculated as the amount of change in the rotation signal generation interval, and the rotational speed variation amount that has occurred while the crankshaft rotated through a set angular (360° in the above example) range is detected from this amount of change in the rotation signal generation interval, the responsiveness of detecting the rotational speed variation amount can be improved.

The aforementioned set angle is not limited to 360°; the set angle may be set to 180°, 270°, or another angle.

The rotation signal generation interval detection means 2A shown in FIG. 5 can be configured from a timing means or timer that measures the rotation signal generation interval for each of the cylinders every time the rotation signal generation means generates a rotation signal that corresponds to each of the cylinders, with an amount of time elapsed from the previous generation to the current generation of the rotation signal that corresponds to each of the cylinders of the engine used as the rotation signal generation interval for each of the cylinders, and the rotation signal generation interval change amount calculation means 2B can be configured from a means that calculates the absolute values of the differences between the currently measured rotation signal generation interval for each of the cylinders and the previously measured rotation signal generation interval for each of the cylinders as the amounts of change in the rotation signal generation interval for each of the cylinders every time the timing means measures the rotation signal generation interval for each of the cylinders. The rotational speed variation amount detection means 2C can be configured so that every time the rotation signal generation interval change amount calculation means 2B calculates the amounts of change in the rotation signal generation interval for each of the cylinders, the rotational speed variation amount detection means 2C uses the calculated amount of change in the rotation signal generation interval for each of the cylinders to detect the rotational speed variation amount of the engine that has occurred while the crankshaft rotated through a set angular range.

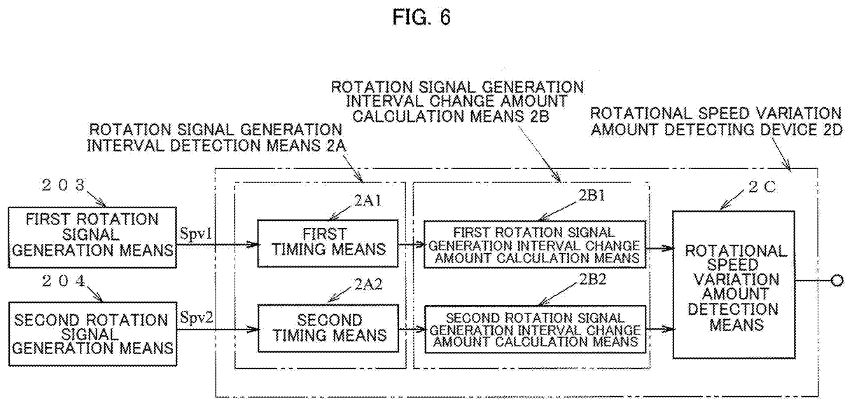

FIG. 6 shows an example of the configuration of the rotation signal generation interval detection means 2A, the rotation signal generation interval change amount calculation means 2B, and the rotational speed variation amount detection means 2C in a case that the engine is a two-cylinder four-cycle engine which has a first cylinder and a second cylinder and every time a crankshaft rotates once, an ignition action is performed one time each in the first cylinder and the second cylinder. In this example, the rotation signal generation interval detection means is configured so that every time a rotation signal generation interval for each of the cylinders are newly detected, the difference between the newly detected rotation signal generation interval for each of the cylinders and the previously detected rotation signal generation interval for each of the cylinders is calculated as an amount of change in the rotation signal generation interval.

The rotation signal generation interval detection means 2A shown in FIG. 6 is configured from a first timing means 2A1 that measures, as a first rotation signal generation interval, the interval at which the ignition action is performed in the first cylinder 101, and a second timing means 2A2 that measures, as a second rotation signal generation interval, the interval at which the ignition action is performed in the second cylinder 102. The rotation signal generation interval change amount calculation means 2B is configured from a first rotation signal generation interval change amount calculation means 2B 1 that calculates an absolute value of a difference between the first rotation signal generation interval currently measured by the first timing means and the previously measured first rotation signal generation interval as a first rotation signal generation interval change amount including information on the rotational speed variation amount that has occurred while the engine made one rotation, and a second rotation signal generation interval change amount calculation means 2B2 that calculates an absolute value of a difference between the second rotation signal generation interval currently measured by the second timing means 2A2 and the previously measured second rotation signal generation interval as a second rotation signal generation interval change amount including information on the rotational speed variation amount that has occurred while the engine made one rotation. The rotational speed variation amount detection means 2C is configured so as to detect the rotational speed variation amount of the engine that has occurred while the crankshaft rotated once, every time the first rotation signal generation interval change amount calculation means 2B 1 and the second rotation signal generation interval change amount calculation means 2B2 respectively calculate the first rotation signal generation interval change amount and the second rotation signal generation interval change amount.

The first timing means 2A1 shown in FIG. 6 can be configured so as to measure the first rotation signal generation interval by measuring the generation interval of the first rotation signal generated by the first rotation signal generation means 203 when a high voltage for ignition is applied to the first spark plug PL1 from the first ignition coil IG1 provided to the first ignition unit IU1. The second timing means 2A2 can be configured so as to measure the second rotation signal generation interval by measuring the generation interval of the second rotation signal generated by the second rotation signal generation means 204 when a high voltage for ignition is applied to the second spark plug PL2 from the second ignition coil IG2.

The first rotation signal generation interval change amount calculation means 2B1 shown in FIG. 6 can be configured so as to calculate, as the first rotation signal generation interval change amount, the absolute value |#1N0−#1N1| of the difference between the first rotation signal generation interval #1N0 newly measured by the first timing means 2A1 and the first rotation signal generation interval #1N1 previously measured by the first timing means.

The second rotation signal generation interval change amount calculation means 2B2 can be configured so as to calculate, as the second first rotation signal generation interval change amount, the absolute value |#2N0−#2N1| of the difference between the second rotation signal generation interval #2N0 newly measured by the second timing means 2A2 and the second rotation signal generation interval #2N1 previously measured by the second timing means 2A2. In this case as well, the rotational speed variation amount detection means 2C is configured so as to detect the rotational speed variation amount of the engine every time the first rotation signal generation interval change amount calculation means 2B1 and the second rotation signal generation interval change amount calculation means 2B2 respectively calculate the first rotation signal generation interval change amount and the second rotation signal generation interval change amount.

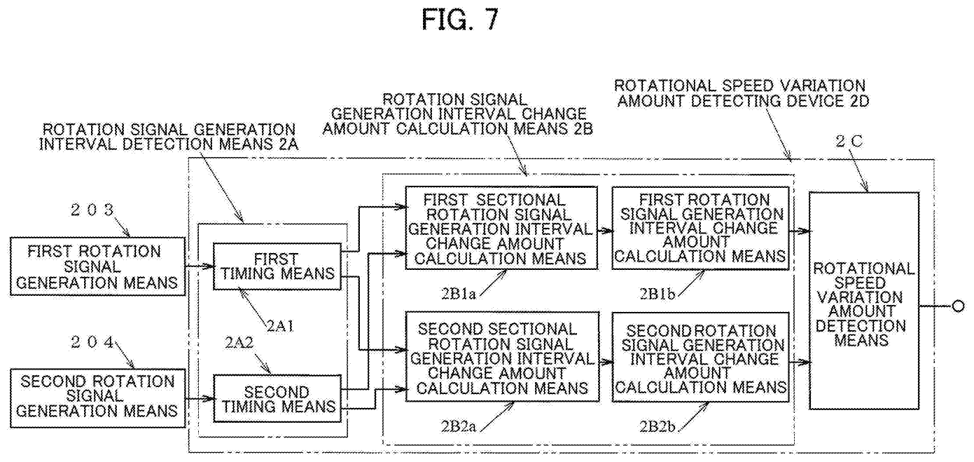

Referring to FIG. 7, this diagram shows another configuration example of the rotational speed variation amount detecting device 2D suitable for use when the engine is a V-type two-cylinder engine. The engine used in the present embodiment has a first cylinder and a second cylinder. While the crankshaft rotates 720°, the ignition action in the first cylinder is performed at a first crank angle position, after which the ignition action in the second cylinder is performed at a second crank angle position distanced a certain angle α° (≤360°) from the first crank angle position, and the ignition action in the first cylinder is performed at a third crank angle position distanced a certain angle (360−α°) from the second crank angle position, after which the ignition action in the second cylinder is performed at a fourth crank angle position distanced a certain angle α° from the third crank angle position.

The rotation signal generation interval detection means 2A shown in FIG. 7 is configured from a first timing means 2A1 that measures, as a first rotation signal generation interval, the generation interval of the first rotation signal S1 generated by the first rotation signal generation means 203 when the ignition action is performed in the first cylinder 101, and a second timing means 2A2 that measures, as a second rotation signal generation interval, the generation interval of the second rotation signal S2 generated by the second rotation signal generation means 204 when the ignition action is performed in the second cylinder 102.

The rotation signal generation interval change amount calculation means 2B is configured from a first per-range rotation signal generation interval change amount calculation means 2B1a, a second per-range rotation signal generation interval change amount calculation means 2B2a, a first rotation signal generation interval change amount calculation means 2B b, and a second rotation signal generation interval change amount calculation means 2B2b.

The first per-range rotation signal generation interval change amount calculation means 2B1a is a means that calculates, as a first per-range rotation signal generation interval change amount including information on the rotational speed variation amount of the crankshaft that has occurred while the crankshaft rotated through a (360−α°) range, an absolute value of a difference between the currently measured first rotation signal generation interval and the second rotation signal generation interval measured by the second timing means 2A2 immediately before the first timing means 2A1 measured this first rotation signal generation interval, this calculation being made every time the first timing means 2A1 measures the first rotation signal generation interval.

The second per-range rotation signal generation interval change amount calculation means 2B2a is a means that calculates, as a second per-range rotation signal generation interval change amount including information on the rotational speed variation amount of the crankshaft that has occurred while the crankshaft rotated through an α° range, an absolute value of a difference between the currently measured second rotation signal generation interval and the first rotation signal generation interval measured by the first timing means 2A1 immediately before the second timing means 2A2 measured this second rotation signal generation interval, this calculation being made every time the second timing means 2A2 measures the second rotation signal generation interval.

Furthermore, the first rotation signal generation interval change amount calculation means 2B1b is a means that performs a calculation to convert the first per-range rotation signal generation interval change amount to a first rotation signal generation interval change amount including information on the amount of change in speed during one crankshaft rotation, and the second rotation signal generation interval change amount calculation means 2B2b is a means that performs a calculation to convert the second per-range rotation signal generation interval change amount to a second rotation signal generation interval change amount including information on the amount of change in speed during one crankshaft rotation.

The rotational speed variation amount detection means 2C is a means that detects the rotational speed variation amount of the engine every time the first rotation signal generation interval change amount calculation means 2B1b and the second rotation signal generation interval change amount calculation means 2B2b respectively calculate the first rotation signal generation interval change amount and the second rotation signal generation interval change amount.

In a case in which the engine is configured so that a spark discharge caused in the first spark plug PL1 and the second spark plug PL2 due to a high voltage for ignition being applied from the first and second ignition coils IG1 and IG2 respectively to the first and second spark plugs PL1 and PL2 attached respectively to the first cylinder 101 and the second cylinder 102 of the engine, the first and second timing means, the first and second per-range rotation signal generation interval change amount calculation means, and the first and second rotation signal generation interval change amount calculation means can be configured as described below.

Specifically, the first timing means 2A1 can be configured so as to measure the rotation signal generation interval of the first cylinder 101 by measuring the generation interval of the first rotation signal S1 generated by the first rotation signal generation means 203 when a high voltage for ignition is applied from the first ignition coil IG1 to the first spark plug PL1. Additionally, the second timing means 2A2 can be configured so as to measure the rotation signal generation interval of the second cylinder 102 by measuring the generation interval of the second rotation signal S2 generated by the second rotation signal generation means 204 when a high voltage for ignition is applied from the second ignition coil IG2 to the second spark plug PL2.

The first per-range rotation signal generation interval change amount calculation means 2B1a can be configured so as to calculate, as the first per-range rotation signal generation interval change amount, the absolute value |#1N0−#2N0| of the difference between the newly measured first rotation signal generation interval #1N0 and the second rotation signal generation interval #2N0 measured by the second timing means 2A2 immediately before the first timing means 2A1 measured the first rotation signal generation interval #1N0, this calculation being made every time the first timing means 2A1 measures the first rotation signal generation interval #1N0. Additionally, the second per-range rotation signal generation interval change amount calculation means 2B2a can be configured so as to calculate, as the second per-range rotation signal generation interval change amount, the absolute value |#2N0−#1N1| of the difference between the newly measured second rotation signal generation interval #2N0 and the first rotation signal generation interval #1N1 measured by the first timing means immediately before the second timing means 2A2 measures the second rotation signal generation interval #2N0, this calculation being made every time the second timing means 2A2 measures the second rotation signal generation interval #2N0.

The first rotation signal generation interval change amount calculation means 2B1b can be configured so as to perform the calculation |#1N0−#2N0|×{360/(360−α)} on the first per-range rotation signal generation interval change amount |#1N0−#2N0|, and to convert the first per-range rotation signal generation interval change amount to a first rotation signal generation interval change amount including information on the amount of change in rotational speed during one rotation of the crankshaft. The second rotation signal generation interval change amount calculation means 2B2b can be configured so as to perform the calculation |#2N0−#1N1|×(360/a) on the second per-range rotation signal generation interval change amount |#2N0−#1N|, and to convert the second per-range rotation signal generation interval change amount to a second rotation signal generation interval change amount including information on the amount of change in rotational speed during one rotation of the crankshaft.

In the embodiment described above, a flywheel magnet is attached to the engine, the flywheel magnet being provided with: a magnetic rotor M joined to the crankshaft of the engine; and ignition units IU1 and IU2, each formed into unit by having a case accommodate an armature core having at both ends a magnetic pole part facing magnetic poles of the magnetic rotor with gaps interposed therebetween, an ignition coil composed of a primary coil and a secondary coil wound around the armature core, and a constituent element of a primary current control circuit that controls a primary current of the ignition coil so as to induce a high voltage for ignition in the secondary coil of the ignition coil at the ignition period of the engine, whereby a high voltage for ignition is applied to spark plugs IL1 and IL2 from the secondary coils of the ignition coils in the first ignition units IU1 and IU2. But the present invention can also be applied to a case of a configuration in which ignition units such as those described above are not used, ignition circuits that control the primary currents of the ignition coils IG1 and IG2 are provided within an electronic control unit (ECU) 2, and the ignition coils IG1 and IG2 are provided on the outside of the electronic control unit.

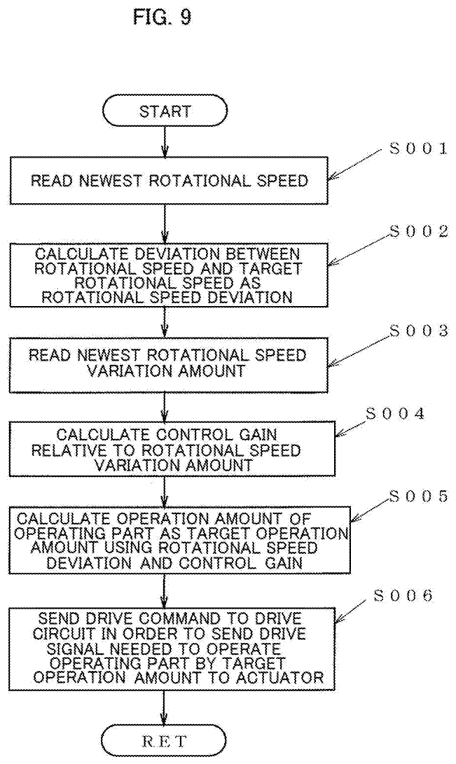

Next is a description, made with reference to FIGS. 9 to 13, of an example of an algorithm of a process the CPU of the microprocessor is caused to execute in order to configure the engine control device according to the present invention. FIG. 9 shows an example of an algorithm of a process repeatedly performed by the CPU in an infinitesimal time interval, in order to perform control causing the rotational speed of the engine to converge on a set speed when the rotational speed of the engine has fluctuated due to a load fluctuation in the generator GEN.

When the algorithm shown in FIG. 9 is followed, first, the newest rotational speed detected by the rotational speed detection means 2E (see FIG. 5) is read in step S001, and then in step S002, a deviation between the read newest rotational speed and the target rotational speed is calculated. Next, in step S003, the newest rotational speed variation amount detected by the rotational speed variation amount detecting device 2D is read, and in step S004, a control gain is calculated relative to the rotational speed variation amount, after which the process advances to step S005, and an operation amount of an operating part (the throttle valve THV in the present embodiment) is calculated as a target operation amount using the rotational speed deviation calculated in step S002 and the control gain calculated in step S004. Next, in step S006, a drive command needed to operate the operating part by a target operation amount is sent to the drive circuit 207, a drive signal needed to operate the operating part (throttle valve) by the target operation amount is sent from the drive circuit 207 to the actuator 5, and the rotational speed of the engine is brought nearer to the target rotational speed. By repeating these steps, the rotational speed of the engine is kept at the target rotational speed and the output frequency of the generator GEN is kept constant.

When the process using the algorithm shown in FIG. 9 is performed, the speed deviation calculation part 2F of FIG. 5 is configured from steps S001 and S002, and the control gain calculation part 2G is configured from steps S003 and S004. The operation amount calculation part 2H of FIG. 5 is configured from step S005, and the operating part drive means 21 is configured from step S006.

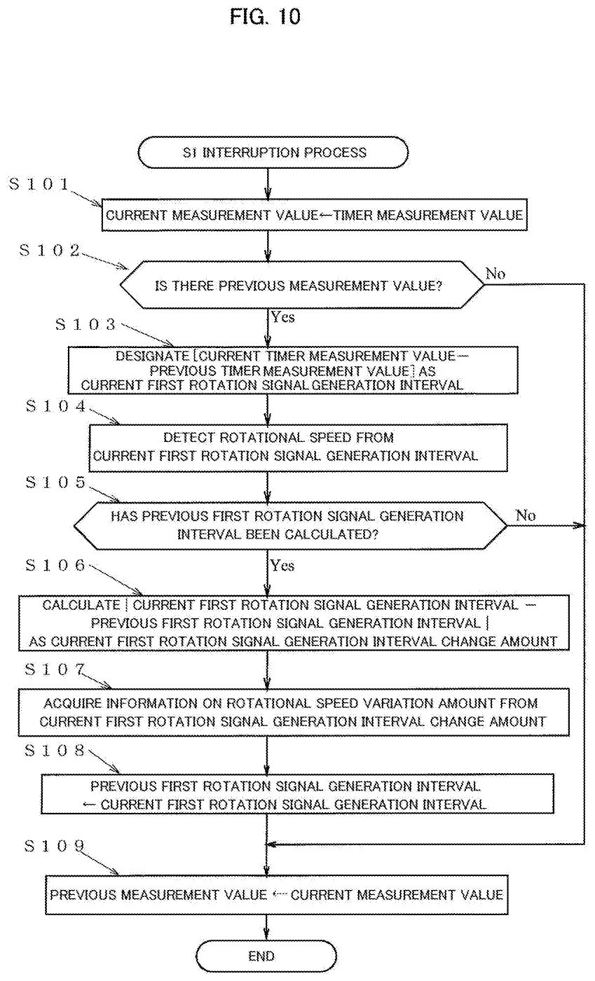

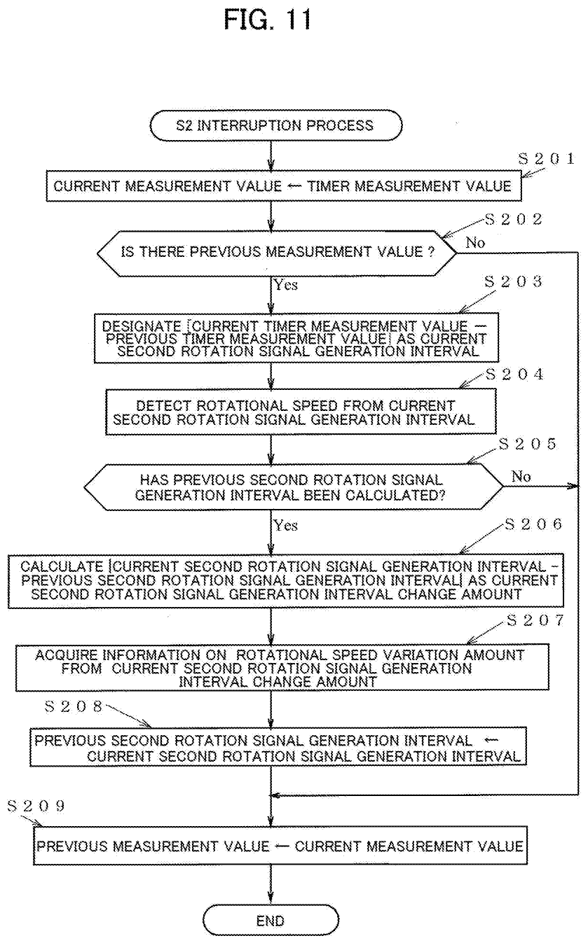

FIGS. 10 and 11 show an interruption process the CPU is caused to execute in order to configure the rotational speed variation amount detecting device 2D shown in FIG. 6 and the rotational speed detection means 2E shown in FIG. 5. FIG. 10 shows an S1 interruption process performed every time the first rotation signal generation means 203 generates the first rotation signal S1 at the ignition position of the first cylinder of the engine, and FIG. 11 shows an S2 interruption process performed every time the second rotation signal generation means 204 generates the second rotation signal S2 at the ignition position of the second cylinder.

When the first rotation signal generation means 203 generates the rotation signal S1 for the first cylinder at the ignition position of the first cylinder, first, in step S101 of FIG. 10, the measurement value of the free-run timer provided to the MPU is read as a “current measurement value,” and then in step S102, a determination is made as to whether or not there exists a measurement value (previous measurement value) of the timer read at the previous ignition position of the first cylinder. When a previous measurement value is determined to not exist in this determination (when the current first cylinder ignition is the ignition of the first cylinder performed first after the startup operation of the engine has been initiated), the interruption process transitions to step S109, a process is performed to designate the current measurement value as the previous measurement value, and this interruption process is then ended.

When it has been determined in step S102 of FIG. 10 that a previous measurement value exists, the process advances to step S103, and a value obtained by subtracting the previous timer measurement value from the current measurement value is stored in the RAM as the current first rotation signal generation interval (#1N0). The process then advances to step S104, and after the newest rotational speed of the engine has been detected from the current first rotation signal generation interval, a determination is made in step S105 as to whether or not the previous first rotation signal generation interval (#1N1) has been calculated. As a result, when it has been determined that the previous first rotation signal generation interval (#1N1) has not been calculated, the interruption process advances to step S109, a process is performed to designate the current timer measurement value measured in step S101 as the previous measurement value, and this interruption process is then ended.

When it has been determined in step S105 of FIG. 10 that the previous first rotation signal generation interval (#1N1) has been calculated, the process advances to step S106, a calculation is performed to find the absolute value of the difference between the current first rotation signal generation interval (#1N0) and the previous first rotation signal generation interval (#1N1) as the current first rotation signal generation interval change amount, and information on the rotational speed variation amount of the engine is acquired from the current first rotation signal generation interval change amount in step S107. Next, in step S108, a process is performed to designate the current first rotation signal generation interval as the previous first rotation signal generation interval, and in step S109, a process is performed to designate the current timer measurement value measured in step S101 as the previous measurement value, after which this interruption process is ended.

When the second rotation signal generation means 204 generates the second rotation signal S2 at the ignition position of the second cylinder, the S2 interruption process shown in FIG. 11 is performed. In this interruption process, first, in step S201, the measurement value of the free-run timer is read as the “current measurement value,” and then in step S202, a determination is made as to whether or not a read timer measurement value (a previous measurement value) exists at the previous ignition position of the second cylinder. As a result of this determination, when a previous measurement value does not exist, the interruption process transitions to S209 and a process is performed to designate the current timer measurement value as the previous measurement value, and this interruption process is then ended.

When it has been determined in step S202 that a previous measurement value exists, in step S203, a value obtained by subtracting the previous timer measurement value from the current measurement value is stored in the RAM as the current second rotation signal generation interval (#2N0), and in step S204, the newest rotational speed of the engine is detected from the current second rotation signal generation interval. Next, in step S205, a determination is made as to whether or not the previous second rotation signal generation interval (#2N1) has been calculated, and as a result of this determination, when it has been determined that the previous second rotation signal generation interval (#2N1) has not been calculated, the interruption process advances to step S209, a process is performed to designate the current timer measurement value measured in step S206 as the previous measurement value, and this process is then ended.

In step S205 of FIG. 11, when it has been determined that the previous second rotation signal generation interval (#2N1) has been calculated, the process advances to step S206, a calculation is performed to find the absolute value of the difference between the current second rotation signal generation interval (#2N0) and the previous second rotation signal generation interval (#2N1) as the current second rotation signal generation interval change amount, and in step S207, information on the rotational speed variation amount of the engine is acquired from the current second rotation signal generation interval change amount. Then, in step S208, a process is performed to designate the second rotation signal generation interval change amount currently calculated in step S206 as the previous second rotation signal generation interval change amount, after which the interruption process advances to step S209, a process is performed to designate the timer measurement value measured in step S201 as the previous measurement value, and this interruption process is then ended.

When the process using the algorithm shown in FIGS. 10 and 11 is performed, the first timing means 2A1 of FIG. 6 is configured from steps S101 to S103 of FIG. 10, and the first rotation signal generation interval change amount calculation means 2B1 is configured from steps S105 and S106. Additionally, the second timing means 2A2 of FIG. 6 is configured from steps S201 to S203 of FIG. 11, and the second rotation signal generation interval change amount calculation means 2B2 is configured from steps S205 and S206. Furthermore, the rotational speed variation amount detection means 2C is configured from step S107 of FIG. 10 and step S207 of FIG. 11, and the rotational speed detection means 2E of FIG. 5 is configured from step S104 of FIG. 10 and step S204 of FIG. 11.

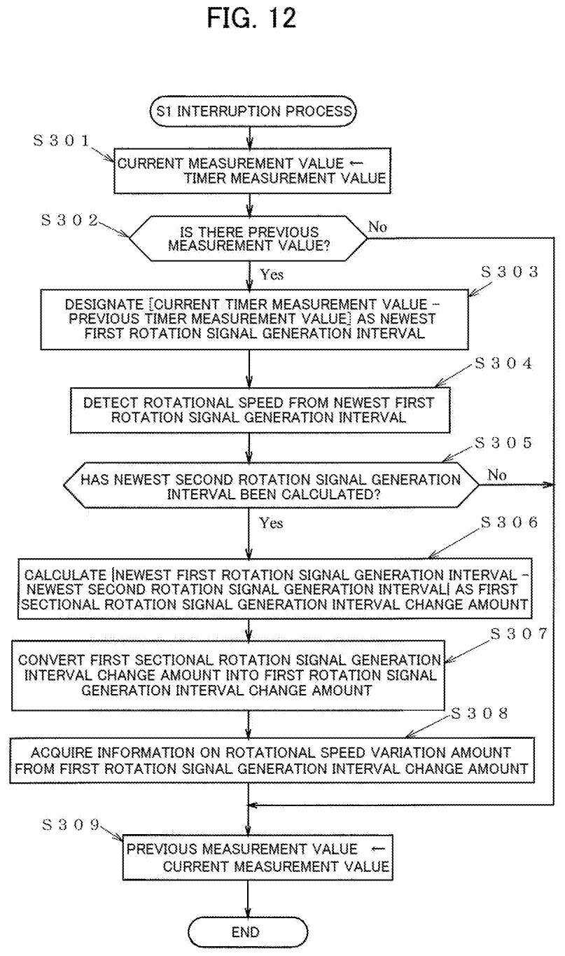

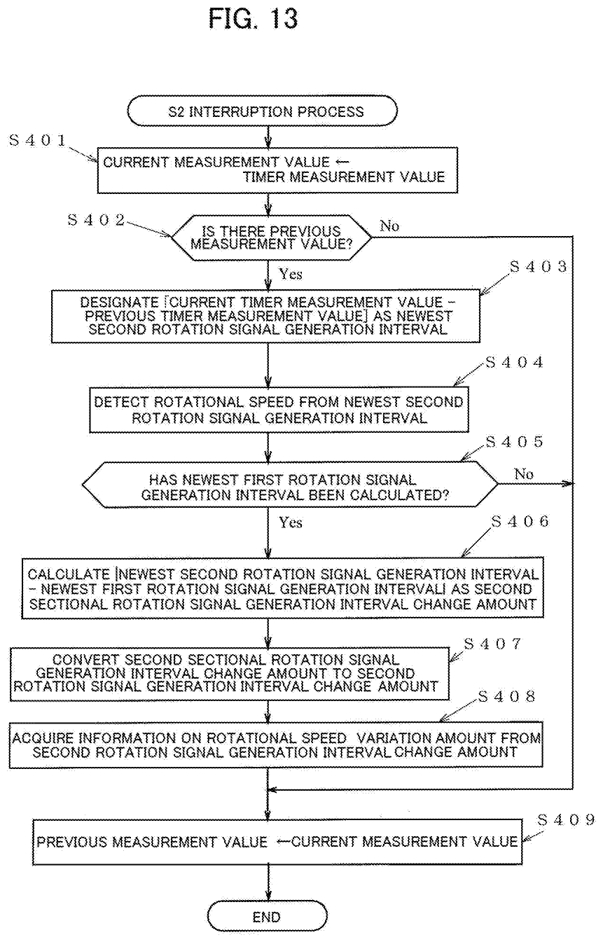

FIGS. 12 and 13 show an interruption process the CPU is caused to perform in order to configure the rotational speed variation amount detecting device 2D shown in FIG. 7 and the rotational speed detection means 2E shown in FIG. 5. FIG. 12 shows an S1 interruption process performed every time the first rotation signal generation means 203 generates the first rotation signal S1 at the ignition position of the first cylinder, and FIG. 13 shows an S2 interruption process performed every time the second rotation signal generation means 204 generates the second rotation signal S2 at the ignition position of the second cylinder.

When the first rotation signal S1 is generated at the ignition position of the first cylinder of the engine, in step S301 of FIG. 12, the measurement value of the free-run timer is read as a “current measurement value.” Next, in step S302, a determination is made as to whether or not there exists a measurement value (previous measurement value) of the timer read at the previous ignition position of the first cylinder. When a previous measurement value is determined to not exist as a result of this determination, the interruption process transitions to step S309, a process is performed to designate the current timer measurement value measured in step S301 as the previous measurement value, and this interruption process is then ended.

When it has been determined in step S302 that a previous timer measurement value exists, the process advances to step S303, and a value obtained by subtracting the previous timer measurement value from the current measurement value is stored in the RAM as the newest first rotation signal generation interval (#1N0). The process then advances to step S304, and after the newest rotational speed of the engine has been detected from the newest first rotation signal generation interval, a determination is made in step S305 as to whether or not the newest second rotation signal generation interval (#2N0) has been calculated. As a result, when it has been determined that the newest second rotation signal generation interval (#2N0) has not been calculated, the interruption process transitions to step S309, a process is performed to designate the current timer measurement value measured in step S301 as the previous measurement value, and this process is then ended.

When it has been determined in step S305 of FIG. 12 that the newest second rotation signal generation interval (#2N0) has been calculated, the process advances to step S306, a calculation is performed to find the absolute value of the difference between the newest first rotation signal generation interval (#1N0) and the newest second rotation signal generation interval (#2N0) as the first per-range rotation signal generation interval change amount, and the first per-range rotation signal generation interval change amount is converted to a first rotation signal generation interval change amount in step S307. Next, information on the rotational speed variation amount is acquired from the first rotation signal generation interval change amount in step S308, after which the interruption process advances to step S309, a process is performed to designate the current timer measurement value measured in step S301 as the previous measurement value, and this interruption process is ended.

The interruption process of FIG. 13 is performed when the second rotation signal generation means 204 has generated a rotation signal S2 for the second cylinder at the ignition position of the second cylinder. In this interruption process, first, in step S401, the measurement value of the free-run timer is read as a “current measurement value,” and in step S402, a determination is made as to whether or not there exists a measurement value (previous measurement value) of the timer read at the previous ignition position of the second cylinder. As a result, when a previous measurement value is determined to not exist, the interruption process advances to step S409, a process is performed to designate the current timer measurement value measured in step S402 (*6) as the previous measurement value, and this interruption process is then ended.

When it has been determined in step S402 that a previous measurement value exists, the process advances to step S403, and a value obtained by subtracting the previous timer measurement value from the current measurement value is stored in the RAM as the newest second rotation signal generation interval (#2N0). The process then advances to step S404, and after the newest rotational speed of the engine has been detected from the newest second rotation signal generation interval (#2N0), a determination is made in step S405 as to whether or not the newest first rotation signal generation interval (#1N1) has been calculated. As a result, when it has been determined that the newest first rotation signal generation interval (#1N1) has not been calculated, the interruption process transitions to step S409, a process is performed to designate the current timer measurement value measured in step S401 as the previous measurement value, and this interruption process is then ended.

When it has been determined in step S405 of FIG. 13 that the newest first rotation signal generation interval (#1N1) has been calculated, the process advances to step S406, the absolute value of the difference between the newest second rotation signal generation interval (#2N0) and the newest first rotation signal generation interval (#1N1) is calculated as the second per-range rotation signal generation interval change amount, and the second per-range rotation signal generation interval change amount is converted to a second rotation signal generation interval change amount in step S407. Next, information on the rotational speed variation amount is acquired from the second rotation signal generation interval change amount in step S408, after which the interruption process advances to step S409, a process is performed to designate the current timer measurement value measured in step S401 as the previous measurement value, and this interruption process is ended.

When the process using the algorithm shown in FIGS. 12 and 13 is performed, the first timing means 2A1 of FIG. 7 is configured from steps S301 to S303 of FIG. 12. Additionally, the first per-range rotation signal generation interval change amount calculation means 2B1a of FIG. 7 is configured from steps S305 and S306, and the first rotation signal generation interval change amount calculation means 2B1b is configured from step S307. Furthermore, the second timing means 2A2 of FIG. 7 is configured from steps S401 to S403 of FIG. 13, and the second per-range rotation signal generation interval change amount calculation means 2B2a is configured from steps S405 and S406. The second rotation signal generation interval change amount calculation means 2B2b of FIG. 7 is configured from step S407 of FIG. 13, and the rotational speed variation amount detection means 2C of FIG. 7 is configured from step S308 of FIG. 12 and step S408 of FIG. 13. The rotational speed detection means 2E of FIG. 5 is configured from step S304 of FIG. 12 and step S404 of FIG. 13.

In the embodiment described above, the rotation signal generation means are configured so as to detect ignition pulses induced in the primary coils of the ignition coils in the ignition units provided for the cylinders and to generate rotation signals that correspond to the cylinders during the ignition periods of the cylinders of the engine, but the rotation signals used in order to detect the rotational speed variation amount of the engine are preferably signals generated once at certain crank angle positions every time the crankshaft rotates once, and are not limited to signals generated due to ignition pulses being detected.

For example, the rotation signals can be signals generated by the detection of specific portions of the AC voltage Ve shown in FIG. 4(A) and induced, in synchronization with the rotation of the engine, in the generating coils provided inside the ignition units. For example, the rotation signal generation means 203, 204 can be configured so as to generate rotation signals for the cylinders at any crank angle position selected from among a crank angle position taken when there is a rise in (when there is a generation of) any one of first through third half-waves of AC voltage induced in the generating coils provided to the ignition units corresponding to the cylinders of the engine, a crank angle position taken when any one of the first through third half-waves peaks, a crank angle position taken when any one of the first through third half-waves falls to zero after having peaked, and a crank angle position taken when any one of the first through third half-waves reaches a set threshold value.

### INDUSTRIAL APPLICABILITY

The present invention makes it possible to detect, a plurality of times while a crankshaft rotates once, an rotational speed variation amount of an engine that has occurred while the crankshaft rotates through a set angular range. The present invention is widely applicable to cases in which a control gain is set with precision in accordance with a degree of the change in rotational speed, and control must be quickly performed to cause the rotational speed of the engine to converge on a target rotational speed.

### EXPLANATION OF NUMERALS AND CHARACTERS

1 Engine
101 First cylinder
102 Second cylinder
THV Throttle valve
PL1 First spark plug
PL2 Second spark plug
IG1 First ignition coil
IG2 Second ignition coil
GEN AC generator
2 Electronic control unit
203 First rotation signal generation means
204 Second rotation signal generation means
2A Rotation signal generation interval detection means
2A1 First timing means
2A2 Second timing means
2B Rotation signal generation interval change amount calculation means
2B1a First per-range rotation signal generation interval change amount calculation means
2B2a Second per-range rotation signal generation interval change amount calculation means
2B1b First rotation signal generation interval change amount calculation means
2B2b Second rotation signal generation interval change amount calculation means
2C Rotational speed variation amount detection means
2F Speed deviation calculation part
2G Control gain calculation part
2H Operation amount calculation part
2J Operating part

What is claimed is:

1. A rotational speed variation amount detecting device that detects a rotational speed variation amount of a multi-cylinder four-cycle engine provided with an engine body having a plurality of cylinders and a crankshaft linked to pistons provided respectively within the plurality of cylinders, and a plurality of ignition units provided correspondingly with respect to the plurality of cylinders, the ignition units each being provided with a generating coil that generates AC voltage once per one rotation of the crankshaft, the AC voltage having a waveform in which a first half-wave, a second half-wave of different polarity from the first half-wave, and a third half-wave of the same polarity as the first half-wave appear in the stated order,
wherein the rotational speed variation amount detecting device comprises:
a rotation signal generation means that detects a specific portion of the waveform of the AC voltage outputted by the generating coil provided to the ignition unit corresponding to each of the cylinders, and generates a rotation signal that corresponds to each of the cylinders once per one rotation of the crankshaft;
a rotation signal generation interval detection means that, every time the rotation signal generation means generates the rotation signal that corresponds to each of the cylinders, detects, as a rotation signal generation interval for each of the cylinders, an amount of time elapsed from the previous generation to the current generation of the rotation signal that corresponds to each of the cylinders; and
a rotation signal generation interval change amount calculation means that, every time the rotation signal generation interval detection means newly detects the rotation signal generation interval for the cylinders, calculates, as a rotation signal generation interval change amount, either a difference between a newly detected rotation signal generation interval for each of the cylinders and a previously detected rotation signal generation interval for the same cylinder or a difference between the newly detected rotation signal generation interval for each of the cylinders and the most recently detected rotation signal generation interval for the other cylinder; and
the rotational speed variation amount detecting device is configured so as to detect the rotational speed variation amount of the engine on the basis of the rotation signal generation interval change amount calculated by the rotation signal generation interval change amount calculation means every time the rotation signal generation interval detection means detects the rotation signal generation interval for each of the cylinders.

2. The rotational speed variation amount detecting device of claim 1, wherein
the engine is a two-cylinder four-cycle engine having a first cylinder and a second cylinder, in which an ignition action is performed once in each of the first cylinder and the second cylinder every time the crankshaft rotates once;
the rotation signal generation interval detection means is provided with a first timing means that measures, as a first rotation signal generation interval, an interval at which a rotation signal corresponding to the first cylinder is generated, and a second timing means that measures, as a second rotation signal generation interval, an interval at which a rotation signal corresponding to the second cylinder is generated;
the rotation signal generation interval change amount calculation means is provided with a first rotation signal generation interval change amount calculation means that calculates an absolute value |#1N0−#1N1| of a difference between a first rotation signal generation interval #1N0 newly measured by the first timing means and a previously measured first rotation signal generation interval #1N1 as a first rotation signal generation interval change amount including information on the rotational speed variation amount that has occurred while the engine made one rotation, and a second rotation signal generation interval change amount calculation means that calculates an absolute value |#2N0−#2N1| of a difference between a second rotation signal generation interval #2N0 currently measured by the second timing means and a previously measured second rotation signal generation interval #2N1 as a second rotation signal generation interval change amount including information on the rotational speed variation amount that has occurred while the engine made one rotation; and
the rotational speed variation amount detecting device is configured so as to detect the rotational speed variation amount of the engine that has occurred while the crankshaft made one rotation, every time the first rotation signal generation interval change amount calculation means and the second rotation signal generation interval change amount calculation means respectively calculate a first rotation signal generation interval change amount and a second rotation signal generation interval change amount.

3. The rotational speed variation amount detecting device of claim 1, wherein the engine is a V-type two-cylinder engine.

4. The rotational speed variation amount detecting device of claim 1, wherein
the engine is a V-type, two-cylinder, four-cycle engine having a first cylinder and a second cylinder, in which an ignition action in the first cylinder is performed at a first crank angle position, an ignition action in the second cylinder is then performed at a second crank angle position distanced a certain angle α° (≤360°) from the first crank angle position, the ignition action in the first cylinder is performed at a third crank angle position distanced a certain angle (360−α°) from the second crank angle position, and the ignition action in the second cylinder is then performed at a fourth crank angle position distanced the certain angle α° from the third crank angle position, while the crankshaft rotates 720°;
the rotation signal generation interval detection means is provided with a first timing means that measures, as a first rotation signal generation interval, an interval at which a rotation signal corresponding to the first cylinder is generated, and a second timing means that measures, as a second rotation signal generation interval, an interval at which a rotation signal corresponding to the second cylinder is generated; and
the rotation signal generation interval change amount calculation means is provided with: a first per-range rotation signal generation interval change amount calculation means that, every time the first timing means measures the first rotation signal generation interval, calculates, as a first per-range rotation signal generation interval change amount including information on the rotational speed variation amount of the crankshaft that has occurred while the crankshaft has rotated through the (360−α°) range, an absolute value of a difference between the currently measured first rotation signal generation interval and the second rotation signal generation interval measured by the second timing means immediately before the first timing means measures the first rotation signal generation interval; a second per-range rotation signal generation interval change amount calculation means that, every time the second timing means measures the second rotation signal generation interval, calculates, as a second per-range rotation signal generation interval change amount including information on the rotational speed variation amount of the crankshaft that has occurred while the crankshaft has rotated through the α° range, an absolute value of a difference between the currently measured second rotation signal generation interval and the first rotation signal generation interval measured by the first timing means immediately before the second timing means measures the second rotation signal generation interval; a first rotation signal generation interval change amount calculation means that performs a calculation in which the first per-range rotation signal generation interval change amount is converted to a first rotation signal generation interval change amount including information on the amount of change in speed during one rotation of the crankshaft; and a second rotation signal generation interval change amount calculation means that performs a calculation in which the second per-range rotation signal generation interval change amount is converted to a second rotation signal generation interval change amount including information on the amount of change in speed during one rotation of the crankshaft.

5. The rotational speed variation amount detecting device of claim 4, wherein
the first per-range rotation signal generation interval change amount calculation means is configured so as to, every time the first timing means measures the first rotation signal generation interval #1N0, calculate, as the first per-range rotation signal generation interval change amount, an absolute value |#1N0−#2N0| of a difference between a newly measured first rotation signal generation interval #1N0 and a second rotation signal generation interval #2N0 measured by the second timing means immediately before the first timing means measures the first rotation signal generation interval #1N0;
the second per-range rotation signal generation interval change amount calculation means is configured so as to, every time the second timing means measures the second rotation signal generation interval #2N0, calculate, as the second per-range rotation signal generation interval change amount, an absolute value |#2N0−#1N1| of a difference between a newly measured second rotation signal generation interval #2N0 and a first rotation signal generation interval #1N1 measured by the first timing means immediately before the second timing means measures the second rotation signal generation interval #2N0;
the first rotation signal generation interval change amount calculation means is configured so as to perform a calculation |#1N0−#2N0|×{360/(360−α)} on the first per-range rotation signal generation interval change amount |#1N0−#2N0|, and to perform a calculation in which the first per-range rotation signal generation interval change amount is converted to a first rotation signal generation interval change amount including information on the amount of change in speed during one rotation of the crankshaft; and
the second rotation signal generation interval change amount calculation means is configured so as to perform a calculation |#2N0−#1N1|×(360/α) on the second per-range rotation signal generation interval change amount |#2N0−#1N1|, and to perform a calculation in which the second per-range rotation signal generation interval change amount is converted to a second rotation signal generation interval change amount including information on the amount of change in speed during one rotation of the crankshaft.

6. The rotational speed variation amount detecting device of claim 1, wherein
the generating coil provided to each of the plurality of ignition units includes ignition coils that generate high voltage for ignition applied to spark plugs attached to the corresponding cylinders of the engine; and
the rotation signal generation means is configured so as to detect ignition pulses induced in primary coils of the ignition coils provided to each of the plurality of ignition units when the ignition action is performed in each of the plurality of cylinders of the engine, and generate rotation signals for the cylinders.

7. The rotational speed variation amount detecting device of claim 1, wherein the rotation signal generation means is configured so as to generate a rotation signal for each of the cylinders at any crank angle position selected from among a crank angle position taken when there is a rise in any one of first through third half-waves of AC voltage induced in the generating coil provided to the ignition unit corresponding to each of the cylinders of the engine, a crank angle position taken when any one of the first through third half-waves peaks, a crank angle position taken when any one of the first through third half-waves falls to zero after having peaked, and a crank angle position taken when any one of the first through third half-waves reaches a set threshold value.

8. An engine control device that performs control causing a rotational speed of a multi-cylinder four-cycle engine to converge on a target rotational speed, the engine being provided with an engine body having a plurality of cylinders and a crankshaft linked to pistons provided respectively within the plurality of cylinders, and a plurality of ignition units provided correspondingly with respect to each of the plurality of cylinders, the ignition units each being provided with a generating coil that generates AC voltage once per one rotation of the crankshaft, the AC voltage having a waveform in which a first half-wave, a second half-wave of different polarity from the first half-wave, and a third half-wave of the same polarity as the first half-wave appear in the stated order;
wherein the engine control device comprises an operating part operated in order to adjust the rotational speed of the engine, a speed deviation calculation part that calculates a deviation between an actual rotational speed of the engine and the target rotational speed, a rotational speed variation amount detecting device that detects a rotational speed variation amount of the engine that has occurred while the crankshaft rotated through a set angular range, a control gain setting part that sets a control gain in accordance with the rotational speed variation amount detected by the rotational speed variation amount detecting device, an operation amount calculation part that calculates an operation amount of the operating part needed in order to cause the rotational speed of the engine to converge on the target rotational speed using the deviation calculated by the speed deviation calculation part and the control gain set by the control gain setting part, and an operating part drive means that drives the operating part so as to operate the operating part by the operation amount calculated by the operation amount calculation part; and
the rotational speed variation amount detecting device is provided with: a rotation signal generation means that detects a specific portion of the waveform of the AC voltage outputted by the generating coil provided to the ignition unit corresponding to each of the cylinders of the engine, and generates a rotation signal that corresponds to each of the cylinders of the engine once per one rotation of the crankshaft; a rotation signal generation interval detection means that, every time the rotation signal generation means generates the rotation signal that corresponds to each of the cylinders, detects, as a rotation signal generation interval for each of the cylinders, an amounts of time elapsed from the previous generation to the current generation of rotation signal that corresponds to each of the cylinders; and a rotation signal generation interval change amount calculation means that, every time the rotation signal generation interval detection means newly detects the rotation signal generation interval for each of the cylinders, calculates, as a rotation signal generation interval change amount, either a difference between a newly detected rotation signal generation interval for each of the cylinders and a previously detected rotation signal generation interval for the same cylinder or a difference between a newly detected rotation signal generation interval for each of the cylinders and the most recently detected rotation signal generation interval for the other cylinder; the rotational speed variation amount detecting device being configured so as to detect the rotational speed variation amount of the engine on the basis of the rotation signal generation interval change amount calculated by the rotation signal generation interval change amount calculation means every time the rotation signal generation interval detection means detects the rotation signal generation interval for each of the cylinders.

9. The engine control device of claim 8, wherein the engine is a two-cylinder four-cycle engine having a first cylinder and a second cylinder, in which an ignition action is performed once in each of the first cylinder and the second cylinder every time the crankshaft rotates once;
the rotation signal generation interval detection means is provided with a first timing means that measures, as a first rotation signal generation interval, an interval at which a rotation signal corresponding to the first cylinder is generated, and a second timing means that measures, as a second rotation signal generation interval, an interval at which a rotation signal corresponding to the second cylinder is generated;
the rotation signal generation interval change amount calculation means is provided with a first rotation signal generation interval change amount calculation means that calculates an absolute value |#1N0−#1N1| of a difference between a first rotation signal generation interval #1N0 newly measured by the first timing means and a previously measured first rotation signal generation interval #1N1 as a first rotation signal generation interval change amount including information on the rotational speed variation amount that has occurred while the engine made one rotation, and a second rotation signal generation interval change amount calculation means that calculates an absolute value |#2N0−#2N1| of a difference between a second rotation signal generation interval #2N0 currently measured by the second timing means and a previously measured second rotation signal generation interval #2N1 as a second rotation signal generation interval change amount including information on the rotational speed variation amount that has occurred while the engine made one rotation; and
the rotational speed variation amount detecting device is configured so as to detect the rotational speed variation amount of the engine that has occurred while the crankshaft made one rotation, every time the first rotation signal generation interval change amount calculation means and the second rotation signal generation interval change amount calculation means respectively calculate a first rotation signal generation interval change amount and a second rotation signal generation interval change amount.

10. The engine control device of claim 9, wherein the engine is a V-type two-cylinder engine.

11. The engine control device of claim 8, wherein
the engine is a V-type, two-cylinder, four-cycle engine having a first cylinder and a second cylinder, in which an ignition action in the first cylinder is performed at a first crank angle position, an ignition action in the second cylinder is then performed at a second crank angle position distanced a certain angle α° (≤360°) from the first crank angle position, the ignition action in the first cylinder is performed at a third crank angle position distanced a certain angle (360−α°) from the second crank angle position, and the ignition action in the second cylinder is then performed at a fourth crank angle position distanced the certain angle α° from the third crank angle position, while the crankshaft rotates 720°;
the rotation signal generation interval detection means is provided with a first timing means that measures, as a first rotation signal generation interval, an interval at which a rotation signal corresponding to the first cylinder is generated, and a second timing means that measures, as a second rotation signal generation interval, an interval at which a rotation signal corresponding to the second cylinder is generated;
the rotation signal generation interval change amount calculation means is provided with: a first per-range rotation signal generation interval change amount calculation means that, every time the first timing means measures the first rotation signal generation interval, calculates, as a first per-range rotation signal generation interval change amount including information on the rotational speed variation amount of the crankshaft that has occurred while the crankshaft has rotated through the (360−α°) range, an absolute value of a difference between the currently measured first rotation signal generation interval and the second rotation signal generation interval measured by the second timing means immediately before the first timing means measures the first rotation signal generation interval; a second per-range rotation signal generation interval change amount calculation means that, every time the second timing means measures the second rotation signal generation interval, calculates, as a second per-range rotation signal generation interval change amount including information on the rotational speed variation amount of the crankshaft that has occurred while the crankshaft has rotated through the α° range, an absolute value of a difference between the currently measured second rotation signal generation interval and the first rotation signal generation interval measured by the first timing means immediately before the second timing means measures the second rotation signal generation interval; a first rotation signal generation interval change amount calculation means that performs a calculation in which the first per-range rotation signal generation interval change amount is converted to a first rotation signal generation interval change amount including information on the amount of change in speed during one rotation of the crankshaft; and a second rotation signal generation interval change amount calculation means that performs a calculation in which the second per-range rotation signal generation interval change amount is converted to a second rotation signal generation interval change amount including information on the amount of change in speed during one rotation of the crankshaft; and
the rotational speed variation amount detecting device is configured so as to detect the rotational speed variation amount of the engine every time the first rotation signal generation interval change amount calculation means and the second rotation signal generation interval change amount calculation means respectively calculate the first rotation signal generation interval change amount and the second rotation signal generation interval change amount.

12. The engine control device of claim 11, wherein
the first per-range rotation signal generation interval change amount calculation means is configured so as to, every time the first timing means measures the first rotation signal generation interval #1N0, calculate, as the first per-range rotation signal generation interval change amount, an absolute value |#1N0−#2N0| of a difference between a newly measured first rotation signal generation interval #1N0 and a second rotation signal generation interval #2N0 measured by the second timing means immediately before the first timing means measures the first rotation signal generation interval #1N0;
the second per-range rotation signal generation interval change amount calculation means is configured so as to, every time the second timing means measures the second rotation signal generation interval #2N0, calculate, as the second per-range rotation signal generation interval change amount, an absolute value |#2N0−#1N1| of a difference between a newly measured second rotation signal generation interval #2N0 and a first rotation signal generation interval #1N1 measured by the first timing means immediately before the second timing means measures the second rotation signal generation interval #2N0;
the first rotation signal generation interval change amount calculation means is configured so as to perform a calculation |#1N0−#2N0|×{360/(360−α)} on the first per-range rotation signal generation interval change amount |#1N0−#2N0|, and to perform a calculation in which the first per-range rotation signal generation interval change amount is converted to a first rotation signal generation interval change amount including information on the amount of change in speed during one rotation of the crankshaft; and
the second rotation signal generation interval change amount calculation means is configured so as to perform a calculation |#2N0−#1N1|×(360/α) on the second per-range rotation signal generation interval change amount |#2N0−#1N1|, and to perform a calculation in which the second per-range rotation signal generation interval change amount is converted to a second rotation signal generation interval change amount including information on the amount of change in speed during one rotation of the crankshaft.

13. The engine control device of claim 8, wherein the generating coil provided to each of the plurality of ignition units includes an ignition coil that generates high voltage for ignition applied to a spark plug attached to the corresponding cylinder of the engine; and
the rotation signal generation means is configured so as to detect an ignition pulse induced in the primary coil of the ignition coil provided to each of the plurality of ignition units when the ignition action is performed in each of the cylinders of the engine, and generates a rotation signal that corresponds to each of the cylinders.

14. The engine control device of claim 8, wherein the rotation signal generation means is configured so as to generate a rotation signal that corresponds to each of the cylinders at any crank angle position selected from among a crank angle position taken when there is a rise in any one of first through third half-waves of AC voltage induced in the generating coil provided to the ignition unit corresponding to each of the cylinders of the engine, a crank angle position taken when any one of the first through third half-waves peaks, a crank angle position taken when any one of the first through third half-waves falls to zero after having peaked, and a crank angle position taken when any one of the first through third half-waves reaches a set threshold value.

15. The engine control device of claim 8, wherein the engine has, as a load, an AC generator that generates AC output of a commercial frequency.
